(19) United States
(12) Patent Application Publication
(10) Pub. No.: US 2026/0233547 A1
(43) Pub. Date: Aug. 13, 2026

(54) SECURITY DOCUMENT AND METHOD FOR PRODUCING A SECURITY DOCUMENT

(71) Applicant: OVD Kinegram AG, Zug (CH)

(72) Inventors: René STAUB, Zug (CH); Sebastian MADER, Zug (CH); Michael HOFFMANN, Zug (CH); Harald WALTER, Zug (CH)

(21) Appl. No.: 19/471,774

(22) PCT Filed: Mar. 28, 2024
(86) PCT No.: PCT/EP2024/058429

§ 371 Date: Oct. 2, 2025

(30) Foreign Application Priority Data
Apr. 6, 2023 (DE) 10 2023 108 843.2

(51) Int. Cl. B42D 25/324; B42D 25/328

(52) U.S. Cl. CPC B42D 25/324; B42D 25/328

(57) ABSTRACT

A security document (1) having a first security element (2) and having surface structure (3) which overlaps said first security element in an overlap region (41), wherein the surface structure (3) changes light which is incident on and/or radiated from the security element (2) in such a way that, in a first viewing situation, light properties (410, 420) having a defined color difference and/or brightness difference are visible in the overlap region (41) and in the comparison region (42).

The invention relates to a security document and to a method for producing a security document.

It is known for personalization items of security documents, such as are used for example in passports or other ID documents, to be protected against forgery by means of security features in the form of (tactile) surface structures, which have an optical function, on a covering layer. It is also known for the personalization items to be protected against forgery by means of security features in the form of embedded DOVIDs (Diffractive Optically Variable Image Devices).

In the field of ID documents, for example, the photograph of the document owner, and items of personalized data such as the date of birth, have hitherto been protected against tampering by means of a DOVID. The DOVID can also serve for authenticating the document body. Depending on the type of document (paper data page, polycarbonate data page, etc.), forgers seek to change or substitute these data. Known strategies in forgery attempts are “Attack from the front”, “Attack from the middle” and “Attack from the back”. A DOVID lying over the personalized data protects in particular against attacks from the front, such as alteration of the photograph by means of black print on the surface.

Surface structures generated for example by means of structured press plates during the lamination of polycarbonate cards also have the aim of protecting said personalized data. Said surface structures have the advantage that they can be implemented relatively inexpensively during the production of cards. They however also have the disadvantage that they are situated on the surface and are thus easily accessible to forgers for analysis and thus for replication.

To avoid interfering interaction between the optical functions of such security features based on impressed surface structures and DOVIDs, the positioning of these two different security features one above the other is normally avoided. These interactions otherwise reduce the ability to identify and thus inspect one of the security features or even both security features, which in turn impairs protection against forgery. For example, it is made difficult for laypersons to separately inspect the individual security features. For example, diffractive movement effects based on fine lines (fine-line movement) can be identified only with difficulty if scattering matte structures are present on the surface. The identification of diffractive design elements which exhibit a defined form expected by the viewer, for example an emblem/coat of arms or a 2-letter code, is also made more difficult or impossible by overlying surface structures. However, if the two security features are used adjacent to one another and, as is often the case, even with a spacing to one another, this makes the work of the forger easier because, to imitate the two security features, the forger merely needs to concentrate on each one of the security features in turn.

It is therefore an object of the invention to provide a security document that exhibits improved protection against forgery, and an improved method for producing a security document.

The object is achieved by a security document according to claim 1 and a method according to claim 50.

The security document has a first security element having a first optically variable effect in a first region. The security document also has a surface structure arranged on a first outer face of the security document. The surface structure is exposed. The security document also has an overlap region, in which the surface structure overlaps the first security element. The security document furthermore has a comparison region, in which the first security element is present but the surface structure does not overlap the first security element. In a first viewing situation, a reference light property, which is a defined color and/or defined brightness, is visible in the comparison region. The surface structure is configured such that, in the first viewing situation, the surface structure in the overlap region causes a change in light which is incident on the first security element and/or a change in light which is radiated from the first security element, such that a contrasting light property, which is a defined color and/or defined brightness and which is generated by the first optically variable effect of the first security element, is visible in the overlap region.

Here, the contrasting light property differs from the reference light property by a defined color difference and/or a defined brightness difference.

The method according to the invention is a method for producing a security document, in particular the security document according to the invention. The method comprises the following steps, in particular in the stated sequence:
providing at least one covering layer;
providing at least one core layer;
providing a first security element having a first optically variable effect;
arranging the at least one core layer, the at least one covering layer and the first security element such that the first security element is arranged between the at least one covering layer and the at least one core layer;
pressing together, in particular laminating, the at least one covering layer and the at least one core layer, wherein a surface structure is impressed into the at least one covering layer such that the surface structure is exposed, and the security document has an overlap region, in which the surface structure overlaps the first security element, and a comparison region, in which the first security element is present but the surface structure does not overlap the first security element. In a first viewing situation, a reference light property, which is a defined color and/or defined brightness, is visible in the comparison region. The surface structure is configured such that, in the first viewing situation, the surface structure in the overlap region causes a change in light which is incident on the first security element and/or a change in light which is radiated from the first security element, such that a contrasting light property, which is a defined color and/or defined brightness and which is generated by the first optically variable effect of the first security element, is visible in the overlap region. Here, the contrasting light property differs from the reference light property by a defined color difference and/or a defined brightness difference.

By means of the invention, a security document that exhibits improved protection against forgery is realized, in particular owing to the presence of a defined interaction between the surface structure and the first security element, said interaction being manifest in the defined color difference and/or brightness difference. It is thus possible that the surface structure together with the first security element forms a security feature which advantageously exhibits complex but defined and thus inspectable color relationships and brightness relationships in particular viewing situations. At the same time, it is possible that the optical functions of the surface structure and of the first security element generate a common image, which in turn is easy to communicate, quick to inspect and difficult to imitate. In particular, a forger must also imitate the defined interaction, and for example cannot merely individually copy both images (of the surface structure and of the first security element) and reproduce them for different viewing situations. Otherwise, it would for example be possible even from a simple visual check to identify the absence of interaction, which can be inspected on the basis of the defined color difference and/or brightness difference in the first viewing situation and is based both on the optically variable effect of the first security element and on the change in the light caused by the surface structure, and in particular on the optically variable effect, correspondingly changed by the surface structure, of the first security element under the surface structure. Furthermore, the common optical image is destroyed if only the surface structure or the first security element is changed.

A further advantage is that considerably larger surface areas of the security document or of the personalization item can be protected by means of the first security element or further security elements which exhibit a corresponding defined color contrast and/or brightness contrast in relation to other surface structures. This does increase the surface area of the security document in which corresponding regions can overlap surface structures. However, owing to the defined interaction, these overlapping areas, rather than having a disruptive effect, can even contribute to an improvement in protection against forgery.

It can furthermore advantageously be achieved that there is a perfect register between the optical effects of the overlap region and of the comparison region, such that, in particular, forgery attempts based on other production methods that are subject to register tolerances can be identified on the basis of such register tolerances.

Advantageous embodiments of the invention are indicated in the dependent claims.

The security document is preferably a passport, an identity card, a driver's license, a label or a vignette or a data page from the aforementioned documents, in particular a data page of a book-like document, for example of a passport.

“Exposed” is to be understood in particular to mean that the surface structure forms an outermost surface of the security document. This may for example be a tactile surface structure. A tactile surface structure is preferably haptically tangible.

It is possible that the first security element comprises one or more of the following layers in the first region: at least one relief structure, and/or at least one replication layer having the at least one relief structure, and/or at least one reflection layer, wherein the reflection layer is arranged on the at least one relief structure. It is also possible that the at least one relief structure comprises a first relief structure which is present both in the overlap region and in the comparison region, and/or that the first relief structure extends, at least in parts, uninterruptedly from the overlap region into the comparison region. Preferably, the first region is a closed region or is made up for example of a plurality of preferably separate subregions, which have the first relief structure and/or one or more further relief structures.

An optically variable effect may in particular be selected individually or in combination from: viewing-angle-dependent contrast, in particular brightness change, viewing-angle-dependent color change, viewing-angle-dependent movement effect, viewing-angle-dependent motif change, holographic image, cinematographic image, three-dimensional image, stereoscopic image. The viewing angle of a security element, in particular of the first security element, may be varied by a user in particular by tilting and/or rotating and/or bending the security element. The optically variable effect of the first security element exhibits in particular different colors and/or different brightnesses in different viewing situations, which include the first viewing situation. The viewing situation is in this case in particular dependent on the viewing angle, which is in particular made up of one or more of the following angles: an illumination angle, a viewing angle, an angle of rotation. Relief structures such as the at least one relief structure are preferably used for this purpose. Relief structures of this type, such as the at least one relief structure, preferably have a sequence of elevations and depressions in at least a direction determined by an associated azimuth angle, the elevations of said sequence preferably following one another with a period P which is for example less than a wavelength of visible light. It is thus possible, for example, for the azimuth angle of the at least one relief structure to be used to predefine the angle of rotation of the view in the case of which a defined color and/or defined brightness is cast by the first security element to a viewer and/or to the first outer face, in particular having the surface structure. The minima of the depressions define in particular a base surface, such that the base surface is preferably spanned by minima of a corresponding relief structure, preferably of the at least one relief structure. A corresponding relief structure, in particular the at least one relief structure, preferably has a relief depth t which is determined by a spacing of the maxima of the elevations of the relief structure to the base surface in a direction perpendicular to the base surface. In particular, the term “grating depth” may also be used instead of “relief depth”. A profile shape is to be understood in particular to mean the shape in a cross-sectional view having a section plane that encompasses the normal to the base surface. Through selection of these parameters, it is possible in particular to specify defined colors and/or defined brightnesses in defined viewing situations, in particular in at least the first viewing situation.

Angles, in particular the viewing angle and the illumination angle, are preferably measured proceeding from a normal to the base surface and/or to a plane spanned by the security document, for example by the first outer face. The angle of rotation is in particular an angle measured within the base surface and/or the plane spanned by the security document, for example by the first outer face. For example, it is conceivable that the angle of rotation an angle between a reference axis, which extends on the base surface or on the plane spanned by the security document, for example by the first outer face, proceeding from the intersection point with the normal, and a further axis, which extends on the base surface or on the plane spanned by the security document, for example by the first outer face, proceeding from the intersection point with the normal, and for example follows a viewing direction projected onto the base surface.

The contrasting light property which is visible in the first viewing situation is in particular a color and/or brightness generated by the first security element, and is thus predetermined by the first optically variable effect. Optionally, the contrasting light property and/or the reference light property may have further color effects and/or brightness effects, for example by coloration of a covering layer which bears the surface structure, and/or by means of a thin-film structure, in particular a Fabry-Pérot interference layer structure. The statement “is generated by the first optically variable effect of the first security element”, and/or a “color and/or brightness generated by the first security element”, is preferably to be understood to mean that the first optically variable effect of the first security element is produced, that is to say is preferably visible to a viewer. The contrasting light property is thus in particular a defined color and/or defined brightness which is produced by the first optically variable effect of the first security element.

The defined color and/or brightness which forms the reference light property is in particular a color and/or brightness generated and/or produced by the first security element, or is a background color and/or background brightness. The background color and/or background brightness is generated in particular by one or more, for example optically invariable, layers which, in a view directed onto the first outer face, are arranged in front of, behind and/or in the first security element. It is possible in particular that the first security element is transparent in the first viewing situation, if the reference light property is a background color and/or background brightness.

It is possible that the defined color and/or defined brightness of the contrasting light property and/or of the reference light property comprises one or more colors, in particular one or more defined value ranges of wavelengths, and/or one or more brightnesses, in particular one or more defined value ranges of brightnesses. These one or more defined colors and/or one or more defined brightnesses may be present in different zones of the overlap region and/or of the comparison region. For example, when viewed in the first viewing situation, the overlap region may be bright and rainbow-colored, and the comparison region may appear dark, in various gray tones. Since, in particular, there is always a defined color difference and/or brightness difference in relation to the comparison region, a security feature which is easy to inspect can thus be provided.

“Light which is radiated from the first security element” is to be understood in particular to mean light which is reflected and/or scattered and/or diffracted by the first security element. This reflected and/or scattered and/or diffracted light is changed at the surface structure, in particular at a boundary between the surface structure and the ambient air, for example by diffraction and/or refraction and/or scattering and/or reflection, such that, from the overlap region of the security document, light having a light property other than the reference light property, such as the contrasting light property, can be radiated to a viewer, in particular in the first viewing situation.

Owing to the change of “light which is incident on the first security element”, it is possible in particular that, in the same viewing situation, from the first security element, the first optically variable effect causes different light to be radiated from the first security element, and made visible to a viewer, in the overlap region than in the comparison region.

It is possible that, in the first viewing situation, the contrasting light property is determined in particular by the first optically variable effect, which is generated by the incident light, which in turn is changed by the surface structure, in particular by refraction, diffraction, scattering and/or reflection. Alternatively or in addition, the contrasting light property is determined in particular by the light which is generated by the optically variable effect of the first security element, which light exits at the surface structure and in the process is changed by the surface structure, in particular by refraction, diffraction, scattering and/or reflection.

The surface structure preferably causes a change in the light which is incident on the first security element, in particular in the angle of the light which is incident on the first security element, preferably in relation to a region of the first security element, in particular the comparison region, which has the same optically variable effect but which does not overlap the surface structure, and/or the surface structure causes a change in the light which exits at the surface, and which has been diffracted, scattered and/or reflected by the first security element, in relation to a region of the first security element, in particular the comparison region, which has the same optically variable effect but which does not overlap the surface structures. In particular, the surface structure changes the optical effect of the first security element which is visible to the viewer, such that, in particular in the first viewing situation, a different optical effect of the first security element is visible in the overlap region than in the comparison region.

The change in light which is incident on the first security element is in particular a change in the angle of incidence of the light which is incident on the first security element, in particular in relation to light which is incident on the first security element preferably without being changed by the surface structure. The change in light which is radiated from the first security element is in particular a change in the angle of emergence of light which is radiated from the first security element, in particular in relation to light which preferably exits the security document at a surface without the surface structure. The change in light which is incident on the first security element, in particular in the angle of incidence, and/or in light which is radiated from the first security element, in particular in the angle of emergence, is in particular in relation to light which is incident on the first security element in the comparison region, in particular after having entered at the first outer face without a surface structure, and/or which is radiated from the first security element and which in particular exits the security document at the first outer face without a surface structure. The change in light which is incident on the first security element (angle of incidence) and/or in light which is radiated from the first security element (angle of emergence) preferably is or comprises one or more of the following changes: variation of the angle of emergence, in particular increase of the angle of emergence, decrease of the angle of emergence, expansion of the angle of emergence and/or focusing of the angle of emergence, variation of the angle of incidence, in particular increase of the angle of incidence and/or decrease of the angle of incidence and/or focusing of the angle of incidence. The angle of incidence is in particular the angle of incidence of light which is incident on the first security element and which has entered the security document at the first outer face, in particular at the surface structure. The angle of emergence is in particular the angle of emergence of light which exits at the first outer face, preferably at the surface structure, and which has been radiated from the first security element.

A color is understood in particular to mean an individual visual (sensory) perception caused by light in the range which is visible to the human eye. This perception is also referred to as color perception or color impression. The colors that are visible to humans lie in the range between 380 nm [violet] and 780 nm [deep red] in the electromagnetic spectrum, wherein, in particular, the relative sensitivity of the eye below 430 nm and above 690 nm is less than 1% of the maximum value at 555 nm. Consequently, in particular in the spectral ranges of 380 nm to 430 nm (wavelengths shorter than light which is clearly visible to the human eye) and 690 nm to 780 nm (wavelengths longer than light which is clearly visible to the human eye), only very strong light sources such as ultrabright LEDs or lasers are still discernible. The color, as that which is perceived, arises from the visual stimulus in color receptors in response to a color valence. Color is not the property of the light seen (color stimulus), but is the subjective sensing of the physical cause of the electromagnetic waves. According to spectral color valence (different intensity in light of different wavelengths), different color stimuli are produced, which give rise to different qualities of color perception, with the result that different colors are perceived.

A defined color difference and/or defined brightness difference arises in particular at least in the first viewing situation.

In particular, it has proven to be advantageous if the defined color difference and/or brightness difference that exists between the contrasting light property and the reference light property is determined by a total color difference dE, preferably in the CIELAB color space, and lies in a range from 3 to 270, preferably in a range from 5 to 270, preferably in a range of 10 to 270.

A brightness difference and/or color difference is preferably determined in the CIELAB color space by the total color difference dE. In particular, in the CIELAB system, the color space is represented by a sphere defined by the three axes brightness L, red-green axis a and yellow-blue axis b. In particular, L=100 corresponds to white, L=0 corresponds to black and L=50 corresponds to the achromatic point. The total color difference dE is furthermore determined as follows:

$$d E = \sqrt{{( dL )}^{2} + {( da )}^{2} + {( db )}^{2}}$$

where in particular “dL” is the brightness difference, the value “da” is the color difference on the red-green axis, and “db” is the color difference on the yellow-blue axis, between two colors. A brightness difference and/or color difference is understood here preferably to mean the total color difference dE. In general, in particular, the following applies: The smaller the difference, the smaller are the color differences. Brightness and/or color differences can be measured using colorimeters such as a spectrophotometer. For example, a measurement may be carried out in particular with an illuminance in a range between 400 and 500 lux (lumens/square meter), wherein the illumination is preferably diffuse.

It is also advantageously possible that the surface structure, which in particular exhibits a colorless and/or achromatic optical effect and/or a colorless and/or achromatic optical image, exhibits the color effects and/or brightness differences of the underlying first security element. In particular, color effects in the first security element which are stable over a relatively large angle range and/or exhibit a defined, preferably clearly defined, color change are advantageous because the region of overlap with the surface structures can also exhibit this color impression and/or color change and/or contrast change.

“Visible to the human eye” or “visible” is to be understood in particular to mean visible in a wavelength range from 380 nm to 780 nm, and in particular from 430 nm to 690 nm.

“Transparent” is preferably to be understood to mean a transmittance of over 70% and in particular over 90%, in particular for wavelengths in a range from 430 nm to 690 nm, preferably for wavelengths in the wavelength range which is visible to the human eye. “Semitransparent” is preferably to be understood to mean a transmittance in a range from 30% to 70%, in particular for wavelengths in a range from 430 nm to 690 nm, preferably for wavelengths in the wavelength range which is visible to the human eye. “Opaque” is preferably to be understood to mean a transmittance of less than 30% and in particular less than 10%, in particular for wavelengths in a range from 430 nm to 690 nm, preferably for wavelengths in the wavelength range which is visible to the human eye. “Transmittance” is preferably understood to mean the ratio of the amount of light which is radiated into and/or incident on a medium to the amount of light which exits the medium on the opposite side, with preferably no significant change in the spectrum profile of the light having occurred. The non-transmitted light is preferably reflected, scattered and/or absorbed by the medium. For example, a transmittance of a medium of 0.9 or of 90% means that 90% of the incident light is perceptible on the opposite side of the medium. In particular, when considering the transmittance of a layer, reflections on the boundaries of said layer are disregarded.

With regard to the first optically variable effect or the first security element, “not visible” is to be understood in particular to mean that a condition for direct reflection by the first security element is not satisfied, such that the optically variable effect and/or the zeroth order color effect is not visible or is almost not visible. Alternatively, with regard to the first optically variable effect or the first security element, “not visible” is to be understood in particular to mean that a condition for diffraction or reflection by the first security element is not satisfied, such that the optically variable effect and/or a first-order and/or higher-order diffractive color effect and/or the reflective brightness effect is not visible or is almost not visible. It is possible here that the first security element can be regarded as transparent. An “order” is to be understood here in particular to mean the order of diffraction.

The surface structure and the first security element preferably generate a common optical image and/or a common optically variable effect, which in particular is not achievable with only one of the two security features, and/or which deviates from the respective individual optical effects of the surface structure and of the first security element. A common optical image is to be understood in particular to mean one or more logically coherent motifs.

A motif is in particular selected individually or in combination from: a graphically designed outline, a figurative representation, an icon, a geometrical shape, a picture, a symbol, a logo, a portrait, an alphanumeric character, a text, a grid, a pattern. “Motif-shaped” is understood in particular to mean “in the form of a motif”.

A region is understood in particular to mean a defined area which extends through the security document and which, in a view directed perpendicularly with respect to a plane which is spanned by the security document, in particular by the first security element, the first outer face and/or the surface structure, in particular a base surface of the at least one relief structure or of the surface structure. Regions, overlaps, widths and lengths are considered in particular in a view directed perpendicularly onto a plane spanned by a corresponding layer, wherein, preferably, the spanned plane is present when the layer thickness of the corresponding layer is disregarded. Regions extend, in particular with the thus defined area as base surface, through the security document or the system. A layer is preferably a substantially planar structure. In particular, a layer may be of single-layer or multi-layer form. “Overlapping” and/or “overlaps” means in particular that there is an at least partial overlap in a view directed perpendicularly onto the first outer face and/or perpendicularly onto a plane spanned by the first outer face.

“In register” is to be understood to mean positional accuracy of two or more plies, elements, regions and/or layers relative to one another. Here, the register accuracy should lie within a predefined register tolerance, and be as close as possible. At the same time, the register accuracy of a plurality of plies, elements, regions and/or layers with respect to one another is an important feature for increasing process reliability and/or product quality as well as protection against forgery. The in-register or accurate positioning may be achieved here in particular by means of register marks which are detectable by sensor means, preferably optically. These register marks may either be special separate plies, elements, regions and/or layers, or may themselves be part of the plies, elements, regions and/or layers to be positioned. “Perfect register” is to be understood in particular to mean that no register tolerance is present.

It is possible that, in one or more further viewing situations, one or more further colors and/or further brightnesses generated by the first security element are visible.

It is possible that the first security element and/or the optically variable effect of the first security element provides and/or produces one or more of the following colors and/or brightnesses and/or properties in the overlap region and/or the comparison region:
at least a first color and/or first brightness, which preferably is produced by the optically variable effect and in particular is visible in the first viewing situation and optionally also in a second viewing situation in the overlap region and preferably forms the contrasting light property;
at least a second color and/or second brightness, which preferably is produced by the optically variable effect and in particular is visible in the first viewing situation in the comparison region and preferably forms the reference light property;
at least a third color and/or third brightness, which preferably is produced by the optically variable effect and in particular is visible in the second viewing situation in the comparison region;
a transparency in the comparison region, in particular such that, in the first or second viewing situation, a fourth color and/or fourth brightness, which preferably is not produced by the optically variable effect, is visible in the comparison region. The fourth color and/or fourth brightness may instead be generated for example by one or more decorative layers, such as one or more printed layers. Here, the one or more printed layers may in particular be arranged under or behind the first security element in a viewing direction.

The first and second viewing situations are preferably mutually different viewing situations. In particular, the contrasting light property corresponds to the first color and/or first brightness, and the reference light property corresponds to the second color and/or second brightness and/or corresponds to the fourth color and/or fourth brightness.

Preferably, the security document in the first viewing situation exhibits a defined interaction in relation to the second viewing situation, for example by virtue of the fact that, in the first viewing situation, the contrasting light property constitutes a defined color and/or defined brightness, which is also present in the second viewing situation at least in the comparison region and/or both in the comparison region and in the overlap region.

It is also conceivable that, in a third viewing situation, the optically variable effect of the first security element is not visible in the overlap region, in particular by virtue of the fact that, in the third viewing situation, the first security element is transparent or semitransparent. In other words, it is possible that, in the third viewing situation, light which is incident on the security document is changed by the surface structure such that the optically variable effect of the first security element is not visible. It is also possible that, in the third viewing situation, the first security element is transparent or semitransparent in the comparison region, or, in the comparison region, a sixth color and/or sixth brightness of the first optical effect is visible which in particular differs from the reference light property and the contrasting light property, preferably by a further defined color difference and/or brightness difference.

In particular, it is also conceivable that the first optically variable effect, which constitutes the contrasting light property in the overlap region, is visible in the comparison region in a fourth viewing situation.

The first, second, third, fourth and fifth color and/or brightness are in particular different colors and/or brightnesses and preferably do not require the presence of one another; rather, the terms “first”, “second”, “third”, “fourth” and “fifth” are preferably used merely for distinction. For example, a “third viewing situation” does not necessarily require the presence of a “second viewing situation”. For example, a “fifth” color does not necessarily require the presence of a “fourth” color.

The security document preferably has at least one covering layer. The surface structure is preferably formed into said covering layer. It is also possible that the security document has at least one core layer. The first security element is preferably applied to the at least one core layer or integrated into a card interior that comprises the at least one core layer. This is preferably achieved by virtue of the first security element being applied to the at least one covering layer and/or to the at least one core layer by lamination and/or a transfer process such as hot stamping or cold stamping. It is also possible that the first security element is applied to a preferably transparent layer which is then arranged between the at least one covering layer and the at least one core layer before said layers are connected to one another. It is preferable if one or more layers of a card core or the at least one core layer consist of or comprise paper and/or consist of or comprise plastics material, in particular polycarbonate (PC) and/or polyvinyl chloride (PVC) and/or Teslin.

The at least one covering layer and the at least one core layer are preferably laminated together in a laminating press. Here, for the at least one covering layer and the at least one core layer, use is preferably made of layers which have a plurality of blanks or security documents and which in particular are separated to form individual security documents in a later step.

The at least one core layer, the at least one covering layer and the first security element are preferably arranged such that the first optical effect of the first security element is present in the first region.

The surface structure may be comprised by and/or formed on the at least one covering layer. To produce the security document, it is possible for the surface structure to be formed into the first outer face by means of a press plate, which in particular has a structure complementary to the surface structure. In particular, the method for producing the security document is carried out in a laminating press, wherein the press plate is used to form the surface structure into the at least one covering layer and to perform the pressing-together operation. Preferably, one or more of the following layers are pressed together and/or laminated during this pressing-together operation: the at least one covering layer, the first security element, a personalization layer, at least one core layer.

The security document furthermore preferably comprises at least one personalization layer. Said personalization layer may, during the production process, be provided and pressed in between the at least one covering layer and the at least one core layer. In a view directed onto the first outer face, the personalization layer is preferably arranged behind the first security element. The personalization layer can preferably be worked by means of a laser, in particular such that personalized information items are or can be formed into the security document by blackening. The blackening may commonly be generated by laser irradiation at a wavelength of 1064 nm. It is also conceivable for the personalization layer to be or comprise at least one printed layer. In particular, the at least one printed layer is applied to the at least one covering layer and/or the at least one core layer before the pressing-together operation, in particular before the lamination process. A printed personalization item may also be applied directly to the core layer.

The at least one covering layer is preferably transparent, in particular such that, in a view directed onto the first outer face, the optically variable effect of the first security element is visible, and in particular the personalized information items are visible, if they are already present.

Preferably, the first security element is applied by means of a laminating film or from a transfer layer of a transfer film.

It is in particular also possible for the at least one relief structure of the first security element to be stamped into a surface that is arranged inside the security document, for example onto a surface, situated inside the security document, of the at least one covering layer, of the at least one core layer, of a transparent layer, preferably of the first transparent layer and/or of the second transparent layer, and/or of the personalization layer. Before or after the at least one relief structure is stamped into a corresponding surface, the at least one reflection layer is preferably applied, in particular at least in the region which is previously or subsequently provided with the at least one relief structure.

The first security element is preferably a diffractive optically variable image device (DOVID), in particular a DOVID which preferably is transparent or is transparent over predominant parts of the area thereof and which preferably partially overlaps a primary picture and/or portrait and/or further personalized data such as the date of birth. “Transparent over predominant parts of the area” means in particular that at least 60% of the area of the DOVID, preferably more than 70% of the area of the DOVID, and in particular more than 80% of the area of the DOVID, are transparent, and preferably only the rest of the area of the DOVID is semitransparent and/or opaque. The area is determined in particular in a view directed perpendicularly onto a plane spanned by the security document and/or by the first security element. The first security element may in particular in the form of an inlay, that is to say in particular an insert element which, during the laminating process, is laminated in by the at least one covering layer and optionally by the at least one core layer on the side situated opposite the at least one covering layer and/or by a further covering layer on the side situated opposite the at least one covering layer. The inlay preferably has at least one carrier film which in particular consists of or comprises polycarbonate. In particular, the at least one replication layer having the at least one relief structure and/or the at least one reflection layer is applied to said carrier film. It is also possible that the security document has a first security element over a full area or in particular over almost a full area, said first security element preferably covering more than 80%, more preferably more than 90%, of the area of the security document, preferably of an area which is visible in a view directed onto the first outer face. It is also possible that the first security element covers at least more than 50% of the area of the security document. The first security element has in particular an areal optical effect, that is to say preferably an effect which is visible to the human eye without the use of magnification aids. The optical effect of the first security element is in particular a preferably areal zeroth order effect or a preferably areal color effect of a Fabry-Pérot interference layer structure.

The at least one covering layer may for example be or comprise a security laminate having the first security element. Such a security laminate is in particular connected to the security document so as to form a surface of the security document such as the first outer face. The security laminate may be connected to the security document by means of a heat-activatable and/or a UV-curing adhesive. A security laminate may for example be a film having the name KINEGRAM® Guard or KINEGRAM® TKO. Such security laminates commonly protect personalized data, such as the portrait of a document owner, on paper-based documents or data pages. It is also possible that plastics cards or plastics card pages consisting of or comprising in particular polycarbonate (PC) are protected by means of the first security element and the surface structure. It is possible here for the first security element to be integrated in a layer composite comprising at least one core layer, before the at least one core layer together with the first security element is pressed together with the at least one covering layer.

In an optional embodiment, the first security element contains no microimages which, in particular together with microlenses situated on the surface and owing to the Moiré magnification effect (or owing to similar technologies such as conventional “flip images”), could constitute an optically variable information item. This is the case in particular because such optically variable movement or flip effects can divert attention from the defined brightness and/or color difference of the optical effect of the first security element.

It is furthermore possible that the security document has further layers, each selected individually or severally in combination from: first transparent layer, in particular consisting of polycarbonate or polyvinyl chloride, second transparent layer, in particular consisting of polycarbonate or polyvinyl chloride, adhesion promoter layer, barrier layer, adhesive layer, mask layer, optical conductor layer, further reflection layer, decorative layer, color layer, further printed layer, further security features.

In particular, it is possible that the security document has one or more of the following layers, preferably in the stated sequence proceeding from the first outer face: the at least one covering layer, the one or more first transparent layers, the personalization layer, the one or more second transparent layers, one or more core layers, which are preferably opaque, one or more third transparent layers, and/or at least one further covering layer. The layers may each be provided, in part or over a full area, with decorative layers such as printed layers and/or color layers.

It is possible that the first security element is applied in one coherent region or in separate regions. Preferably, in particular in a view directed perpendicularly onto a plane spanned by the security document, the first security element at least partially overlaps the personalized data and/or a personalization region, provided for the personalized data, of the personalization layer.

It is possible that, in one or more viewing situations, the first security element is transparent or semitransparent in the overlap region and/or in the comparison region.

Preferably, in a view directed onto the first outer face, the first security element is applied in front of the personalization layer. It is possible that, in a view directed onto the first outer face, one or more further security elements, for example a UV-fluorescent print or a colored offset print, may be present in front of and/or behind the personalization layer.

It is possible that the security document has one or more designs. A design, which in particular constitutes a logically coherent image, is preferably formed in each case by a plurality of design elements.

In particular, it is possible that the first region forms one or more first design elements. It is also possible that the comparison region forms one or more second design elements. It is also possible that the overlap region forms one or more third design elements. It is also possible that the surface structure region forms one or more fourth design elements.

The entire comparison region, or at least one or more subregions of the comparison region which in particular together form at least one second design element, preferably exhibit(s) the reference light property preferably over a full area in the first viewing situation. The entire overlap region, or at least one or more subregions of the overlap region which in particular together form at least one third design element, preferably exhibit(s) the contrasting light property preferably over an area of at least 1 mm×1 mm and more preferably at least 2 mm×2 mm, more preferably at least 3 mm×3 mm, particularly preferably over a full area, in the first viewing situation.

It is possible that the first region comprises a plurality of mutually separate first design elements, and/or that the comparison region comprises a plurality of mutually separate second design elements, and/or that the overlap region comprises a plurality of mutually separate third design elements, and/or that the surface structure region comprises a plurality of mutually separate fourth design elements. Here, “mutually separate” means in particular that the design elements can be perceived by the human eye as being mutually separate, and/or preferably that at least 0.5 mm, preferably at least 2 mm, more preferably at least 5 mm, is present between the respective design elements, in particular in a view directed perpendicularly onto the plane spanned by the first outer face. At least one or more of the second and/or third design elements may be identical to one or more of the first design elements.

Typically, the extent of at least one fourth design element or of the one or more fourth design elements, that is to say in particular design elements of the surface structure, and/or of a first design element or of the one or more first design elements, that is to say in particular design elements of the first security element, lies in a range of 100 μm and 50 mm, preferably in a range from 200 μm to 30 mm, and more preferably in a range of 300 μm and 20 mm. The extent is measured in particular in a view directed perpendicularly onto a plane spanned by the first outer face.

Preferably, the overlap region is in the form of or consists of one or more first motifs which preferably are visible, in particular fully visible, in the first viewing situation. It is also possible that the first region having the first optically variable effect is in the form of one or more second motifs which are visible, in particular fully visible, in particular in the first viewing situation and/or in the second viewing situation, preferably both in the overlap region and in the comparison region. The one or more first and/or second motifs are in particular of a size which is visible to the human eye. The one or more second motifs preferably comprise the one or more first motifs, and/or together with said one or more first motifs form one or more designs. If the one or more second motifs are visible in the overlap region and in the comparison region in the first viewing situation, they advantageously exhibit the defined color difference and/or defined brightness difference.

It is possible that the overlap region, in particular at least one of the third design elements or the one or more third design elements, and/or the comparison region, in particular at least one of the second design elements or the one or more second design elements, has a width of at least 3 mm, preferably at least 6 mm, preferably at least 10 mm, in particular in a view directed perpendicularly onto a plane spanned by the first outer face.

The one or more first motifs preferably have at least one contour line or outer line which extends from the comparison region into the overlap region. Alternatively or in addition, it is possible that the one or more second motifs have at least one contour line or outer line which extends from the comparison region into the overlap region.

The width of the overlap region and/or of the comparison region applies in particular in a Cartesian coordinate system, wherein the plane spanned by the first outer face is spanned by an x axis and a y axis, for only a width in the x direction or in the y direction or for the x direction and the y direction.

It is possible that the at least one relief structure, in particular a first relief structure, completely fills at least one region forming a motif. It is also possible that one or more further relief structures of the at least one relief structure, which differ from the first relief structure, are arranged in one or more further subregions of the first region, wherein the further regions form, for example, further motifs and/or designs.

The surface structure preferably has one or more of the following structures: matte structures, microprisms, microlenses, linear elevations and/or depressions.

It is conceivable that, overlapping the first security element and/or the one or more further security elements, there are one or more further overlap regions with in each case one or more of the aforementioned structures. For example, each further overlap region, or each of at least a plurality of overlap regions, constitutes a different motif and/or is assigned to a different design.

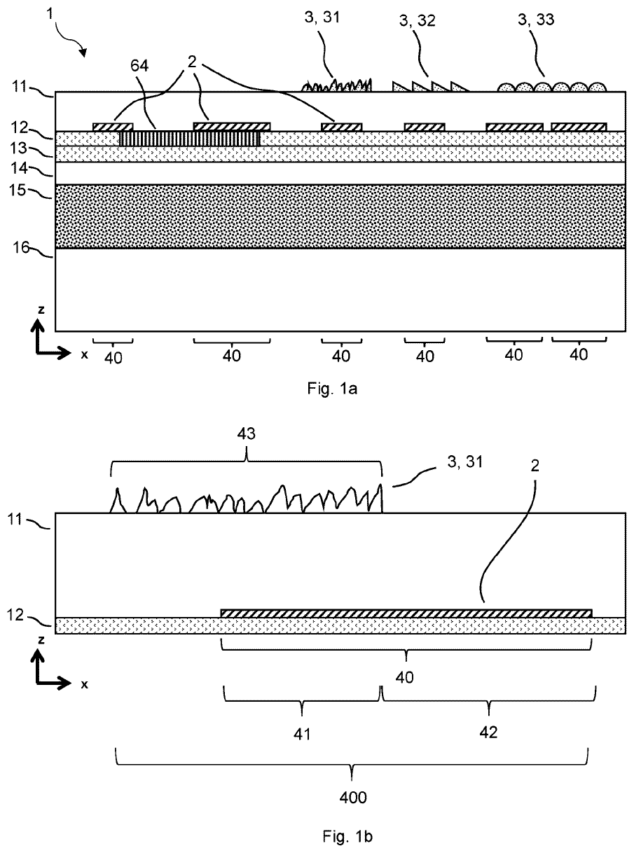

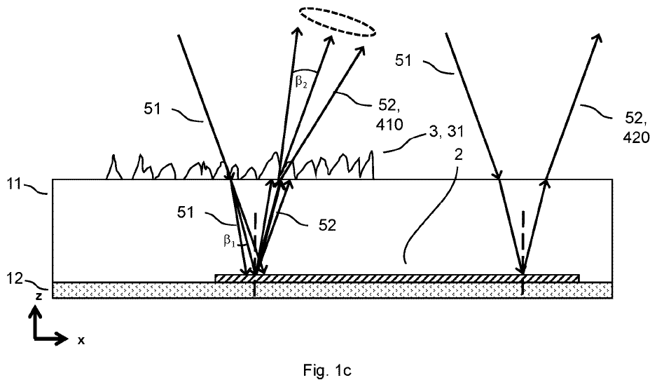

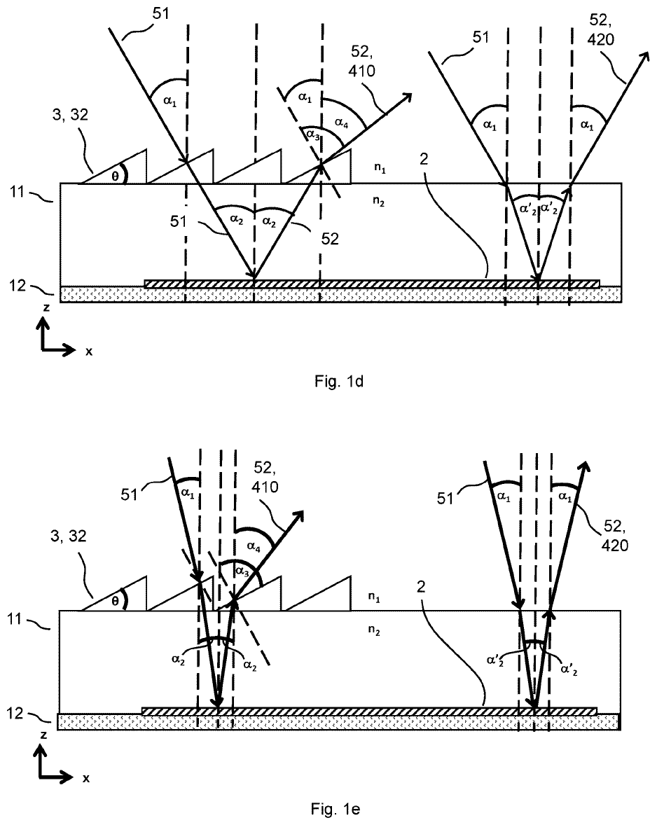

In the comparison region, there is preferably an unstructured surface of the first outer face of the security document. In particular, by means of a preferably unstructured surface of the security document, for example an unstructured surface of the covering layer which consists of or comprises polymer (as illustrated in particular on the basis of FIG. 1d and FIG. 1e) and which is present in air, light which is incident on the security document at an angle α₁ is refracted to an angle α′₂ within the security document, in particular within the covering layer, in accordance with the law of refraction (n₁*sin α₁=n₂*sin α′₂, where n₁ and n₂ are in particular the corresponding refractive indices, for example n₁ of air and n₂ of polymer, which preferably forms the first outer face). The angles of the exiting light after it is reflected on the first security element and after it exits the security document, in particular exits the covering layer, are preferably identical in a particular situation, which may be present for example in the first viewing situation. In particular, in a particular situation, the angle of the light which is radiated from the first security element in the overlap region within the security document, in particular within the covering layer, is identical to the angle of the light which emerges from the security document, in particular from the covering layer, in the comparison region. In particular, in this situation, in the comparison region, the angle of incidence α₁ of light which is incident on the security document, and possibly light which is reflected on the first outer face, may be identical to the exit angle (that is to say also with the value α₁) of light exiting the security document. In particular, in this situation, in the comparison region, the light which is incident on the first security element at the angle α′₂ has the same angle as light which, in the comparison region, is radiated from the first security element within the security document, in particular within the covering layer (and which is thus also radiated at α′₂). In particular, the surface structure preferably changes this. In other words, in the overlap region, the angles are preferably changed in this situation, for example such that, instead of the angle α′₂, an angle α₂ is present, which preferably corresponds to the angle α₁, and/or, instead of the angle α₁ of light exiting the security document, an angle α₄ is present, wherein, in particular, the angle α₄ is greater than or less than the angle α₁. The angles are preferably measured proceeding from a perpendicular to a plane spanned by the security document and/or by the first outer face, and/or are preferably considered in terms of absolute value.

It is possible that the light which exits at the surface structure is expanded by an angle β₂ in a range from 0.5° to 45°, preferably in a range from 2° to 30° and particularly preferably 2° to 15°. This expansion is preferably caused by a matte structure. In particular, the matte structure is configured such that an in particular ideally focused light ray which is incident on the matte structure and which in particular is ideally diffracted and/or reflected in particular by the first security element is expanded by the matte structure on the surface of the security document by an angle β₂ of 0.5° to 45°, preferably of 2° to 30° and particularly preferably 2° to 15°. A matte structure refers in particular to a structure having light-scattering properties, which preferably has a stochastic matte surface profile. The matte structure is preferably an isotropically scattering matte structure. In particular, the matte structure has an average spacing of randomly or pseudorandomly varying elements in a range from 1 μm to 100 μm, preferably in a range from 5 μm to 50 μm. The spacing of the elements may be understood in particular to mean a spacing of maxima, in particular in a roughness profile. The structure depth is in particular the spacing from a maximum to a minimum, in particular in a roughness profile. It is also possible that the matte structure has a structure depth in a range from 0.5 μm to 20 μm, preferably from 1 μm to 10 μm. It is thus possible in particular to achieve high scattering efficiency of the light which is diffracted and/or reflected and/or scattered from the first security element to the surface structure and which exits the security document again through the surface.

The change in light which is incident on the first security element is or comprises in particular a change in the angle of incidence of the light which is incident on the first security element, such that light which passes through the surface structure has a first angle of incidence α₂ on the first security element and light which enters the security document outside the surface structure is incident on the first security element, in particular is incident on the first security element in the comparison region, with a second angle of incidence α′₂. The first angle of incidence α₂ and the second angle of incidence α′₂ preferably have an angle difference of in particular at least 2°, preferably at least 4°, preferably at least 6°, more preferably at least 8° and even more preferably at least 12°. Here, the difference is preferably calculated as an absolute value. Such an angle difference advantageously generates a brightness and/or color difference, which is visible to the eye, in the optical effect of the first security element.

The surface structure preferably has microprisms or consists thereof. It is possible that the angle difference is caused by the microprisms. In particular, the microprisms are or comprise triangular prisms. The lateral extent of the microprisms lies in particular in a range from 5 μm to 200 μm, preferably in a range from 10 μm to 100 μm. The depth of the microprisms lies preferably in a range of 1 μm and 40 μm, preferably between 10 μm and 25 μm. In particular, in a view directed perpendicularly onto a plane spanned by the first outer face, the lateral extent of the microprisms is, with respect to each individual prism, a minimum width in one direction or in all directions in the plane. In the case of all directions, the term “micromirrors” is also used. The depth is measured in particular along the perpendicular to the plane spanned by the first outer face.

It is also possible that the surface structure has or consists of microlenses, wherein, in particular, the microlenses give rise to the angle difference. Microlenses may additionally also generate scattering or expansion of the emergent light, which in particular is similar in terms of optical effect to that of the matte structures. The microlenses are or comprise in particular cylindrical lenses, preferably convex cylindrical lenses, and/or spherical microlenses, preferably in a square or hexagonal arrangement. The microlenses preferably have a lateral extent and/or a diameter which lies in a range from 20 μm to 400 μm, preferably in a range from 40 μm to 300 μm. The microlenses preferably have a depth in a range from 5 μm to 40 μm, preferably from 10 μm to 25 μm. In particular, in a view directed perpendicularly onto a plane spanned by the first outer face, the lateral extent is a minimum width in one direction or in all directions in the plane. The diameter is in particular the diameter of a preferably circular base surface in the case of spherical microlenses, said circular base surface being present in a view directed perpendicularly onto a plane spanned by the first outer face. In particular in the case of a cross section extending perpendicular to the first outer face, the depth is the spacing of minima and maxima along the perpendicular to the first outer face.

It is also possible for the surface structure to have or consist of linear elevations and/or linear depressions. “Linear” is to be understood in particular to mean that a linear contour is present preferably in a view directed perpendicularly onto a plane spanned by the first outer face. The contour may for example be formed by one or more preferably linear maxima and/or one or more preferably linear minima, which for example have and/or form edges, in particular in a view directed perpendicularly onto a plane spanned by the first outer face. Linear elevations and/or depressions extend, in particular so as to follow a line or so as to follow a plurality of lines, with a cross-sectional profile shape which, along the line(s), is constant at least in parts and/or continuously changes at least in parts. The profile shape of the linear elevations and/or depressions is or comprises in particular one or more of the following profile shapes: binary, parabolic, semicircular, polygonal, triangular, that is to say in particular linearly downwardly sloping, symmetrically triangular, asymmetrically triangular.

The lateral extent of the linear elevations and/or depressions runs transversely to the line direction and lies preferably in a range from 10 μm to 300 μm and more preferably from 20 μm to 200 μm. The depth of the linear elevations and/or depressions typically lies in a range from 5 μm to 40 μm and preferably in a range from 5 μm to 25 μm.

The linear elevations and/or depressions may be rectilinear and/or also curved. It is also possible for the linear elevations and/or depressions to be both rectilinear in parts and curved in parts. In particular, they may assume the form of motifs, preferably alphabetic characters, texts or ornaments.

The surface structure, in particular the microlenses and/or the microprisms and/or the linear elevations and/or the linear depressions, cause the angle of light which is incident on the surface structure to be changed, preferably in such a way that, in the first viewing situation, the light thus changed is incident on the first security element such that said light is reflected and/or diffracted and/or scattered by the first security element with the optically variable effect which generates the contrasting light property.

It is possible that the linear elevations and/or depressions give rise to the angle difference.

The at least one relief structure is in particular configured such that color effects are provided by the first security element by diffraction into the zeroth order. Preferably, the contrasting light property and/or the reference light property is produced, in particular in the first viewing situation, by a zeroth order color effect of the first security element, in particular of the at least one relief structure.

The at least one relief structure, in particular the first relief structure and/or at least one of the one or more further relief structures, preferably is or comprises a subwavelength grating for generating zeroth order color effects. Here, the at least one reflection layer preferably is or comprises a metal layer. The subwavelength grating for generating zeroth order color effects preferably has a grating period in a range from 180 nm to 420 nm and a grating depth in a range from 80 nm to 350 nm.

The subwavelength grating for generating zeroth order color effects preferably has an asymmetrical profile shape. In particular, the subwavelength grating for generating zeroth order color effects has a width of elevations and depressions of at least 0.6×P, preferably at least 0.7×P and/or at most 0.4×P, in particular at most 0.3×P, where P is the grating period and t is the relief depth, and the width preferably relates to a spacing of t/2 from the base surface (that is to say is in particular a “full width at half maximum” (FWHM) value). Here, “x” indicates the mathematical operation “multiplied by”. Here, the at least one reflection layer is or comprises in particular a metallic coating, preferably consisting of aluminum, having a thickness in a range from 5 nm to 200 nm. In particular, it is possible that the subwavelength grating for generating zeroth order color effects has one or more of the following shapes: cruciform, hexagonal, pseudorandom. The shape relates here in particular to a view directed perpendicularly onto the base surface. Such shapes advantageously generate particularly intense zeroth order color effects. It is alternatively or additionally also conceivable for the shape to be linear.

The profile shape and/or the relief depth t of the subwavelength grating for generating zeroth order color effects is in particular selected such that the color appearance of the light which is incident on the first security element at at least a first angle of incidence and which is directly reflected by the at least one reflection layer comprising or consisting of a metal layer, or which is directly transmitted through the metal layer, is changed, in particular is changed by plasmon resonance of the metal layer with the incident light. The optical image of the first security element is thus distinguished in particular by a defined (that is to say substantially monochromatic) color impression (for example red or golden), which is preferably visible in a direct reflection and/or in transmission (that is to say in particular under “normal” viewing conditions). The zeroth order color impression is in particular stable over a relatively broad tilt angle range (typically at least 10° to) 20°. In particular, the first viewing situation is a view over a tilt angle range comprising an angle range from 10° to 20°. During tilting to a high degree (for example through) 30°, the color impression preferably changes to a second defined and stable color impression (for example green). Owing to this stability with respect to slight tilting, said color impression preferably differs significantly from so-called rainbow color effects of first-order or higher-order diffraction gratings, which often pass through the entire color palette of the rainbow during a tilting movement through just 10°. Furthermore, the rainbow color effects of diffraction gratings do not appear in a direct reflection, or are not of zeroth order, but appear at different angles, which can be calculated using the diffraction equation. In the case of subwavelength gratings, in particular in the case of subwavelength gratings for generating zeroth order color effects, rainbow color effects can arise, preferably similarly to those in the case of diffraction gratings, during tilting, in particular during tilting through more than 50°.

The surface structure is preferably configured such that, in the first viewing situation, the contrasting light property by a further light property generated in the overlap region by the subwavelength grating for generating zeroth order color effects, in particular is the first color and/or first brightness, and in particular, in the comparison region, the visible reference light property, in particular the second color and/or second brightness, is generated by the subwavelength grating for generating zeroth order color effects, or the reference light property is the fourth color and/or brightness. It is also conceivable that the contrasting light property is a color and/or brightness of a first-order color effect, in particular of a first-order color effect of the subwavelength grating for generating zeroth order color effects. The surface structure may in particular also change the rainbow color effects of subwavelength gratings during a tilting movement such that, owing to the surface structure, said rainbow color effects also occur at other tilt angles, in particular in the first viewing situation, during tilting of the security document. A first-order color effect can thus also arise in the overlap region, said effect being used in particular as the contrasting light property. In other words, it is possible that the reference light property constitutes a first-order color effect which is exhibited by the contrasting light property at a relatively small tilt angle of the security document.

It is also possible that the at least one relief structure, in particular the first relief structure and/or at least one of the one or more further relief structures, is or comprises a grating for generating achromatic lighting-up effects. The grating for generating achromatic lighting-up effects is preferably a diffraction grating. The grating for generating achromatic lighting-up effects preferably has a grating period of at least 3 μm, preferably at least 5 μm, and/or of less than 50 μm, preferably less than 20 μm.

It is also possible that the relief structure for generating achromatic lighting-up effects has one or more of the following, preferably reflective, microstructures: micromirrors, microfacets, microprisms. Expediently, the relief structure for generating achromatic lighting-up effects has one or more of the following profile shapes: blaze-shaped, rectangular, sinusoidal. The structural elements of the relief structure for generating achromatic lighting-up effects have in particular a lateral extent in a range from 3 μm to 50 μm. A lateral extent is preferably measured in a view directed perpendicularly onto a base surface spanned by a corresponding structure, in particular a base surface spanned by the relief structures, wherein, in particular, the base surface is specified on the basis of two axes of a Cartesian coordinate system, and the lateral extent exists in at least one direction of these axes, preferably in both directions.

The at least one reflection layer may in this case be or comprise a metal layer and/or a preferably high-refractive-index (HRI) dielectric layer.

It is possible that the surface structure is configured such that, in the first viewing situation, the contrasting light property exhibits the achromatic effect, in particular owing to an expansion and/or deflection of the exiting light, preferably by means of a matte structure, wherein, in particular, the reference light property which is visible in the comparison region does not exhibit the achromatic effect in the first viewing situation. In particular, the first security element is in this case transparent in the comparison region in the first viewing situation, and/or the fourth color and/or fourth brightness is visible in the comparison region.

It is also possible that, in the first view, owing to the expansion, in particular by a surface structure comprising or consisting of a matte structure, the achromatic effect is visible both in the overlap region and in the comparison region, wherein, in particular, a lower, preferably defined and in particular clearly different brightness is however present in the overlap region.

It is also possible that the at least one relief structure, in particular the first relief structure and/or at least one of the one or more further relief structures, is or comprises a diffraction grating for generating chromatic lighting-up effects. Here, the at least one reflection layer may in particular be or comprise a metal layer and/or a preferably high-refractive-index (HRI) dielectric layer. The diffraction grating for generating chromatic lighting-up effects has in particular a grating period of at least 0.5 μm, in particular at least 0.7 μm, and/or of less than 3 μm, in particular less than 2 μm. Expediently, the diffraction grating for generating chromatic lighting-up effects has one or more of the following profile shapes: blaze-shaped, rectangular, sinusoidal. It is thus possible in particular that the chromatic lighting-up effect still exhibits sufficient angular separation of the different diffracted colors. The profile shape of said diffraction grating is preferably blaze-shaped, because it is thereby possible to realize brighter chromatic effects than is possible with symmetrical profile shapes such as rectangular or sinusoidal profiles. Here, the at least one reflection layer preferably is or comprises a metal layer.

In particular, the surface structure is configured such that, in the first viewing situation, the contrasting light property exhibits a different defined color and/or brightness than the reference light property which is visible in the comparison region. This may be in particular the first color and/or first brightness and the second color and/or second brightness, which are both generated by the first security element.

It is also possible that the at least one relief structure, in particular the first relief structure and/or at least one of the one or more further relief structures, is a subwavelength grating, provided with a preferably high-refractive-index (HRI) dielectric layer as a reflection layer, for generating non-metallic zeroth order color effects. Such subwavelength gratings may generate tilt-angle-dependent and/or azimuth-angle-dependent colors and/or brightnesses. In particular, the first color and/or first brightness, the third color and/or third brightness and/or the fifth color and/or fifth brightness is generated by means of the subwavelength grating for generating non-metallic zeroth order colors and/or brightnesses.

The subwavelength grating for generating non-metallic zeroth order colors and/or brightnesses preferably has a grating period P in a range from 180 nm to 420 nm and/or a grating depth t in a range from 50 nm to 250 nm. Expediently, the subwavelength grating for generating non-metallic zeroth order colors and/or brightnesses has one or more of the following shapes, in particular in a view directed perpendicularly onto a base surface of the at least one relief structure or of the subwavelength grating: linear, cruciform, hexagonal, pseudorandom. It is preferable that the subwavelength grating for generating non-metallic zeroth order colors and/or brightnesses has a profile shape which is rectangular or sinusoidal.

Linear subwavelength gratings generate in particular not only tilt-angle-dependent colors and/or brightnesses but additionally also azimuth-angle-dependent colors and/or brightnesses, in particular a so-called color rotation effect.

In particular, the subwavelength grating for generating non-metallic zeroth order colors and/or brightnesses, which is preferably a linear subwavelength grating, has at least two diffraction gratings having different azimuth angles, wherein respective sequences of elevations and depressions having a defined grating period and a defined grating depth extend along each azimuth angle. It is thus possible that, if the viewing direction extends along the azimuth angle of the at least one relief structure, the associated color effect and/or brightness effect is visible.

In particular, the first security element, preferably the subwavelength grating for generating non-metallic zeroth order colors and/or brightnesses, may provide either the effect of an, in particular quasi-continuous, migration of the color and/or of a colored image change (image flip).

The subwavelength grating for generating non-metallic zeroth order colors and/or brightnesses in the first security element is preferably provided with an in particular high-refractive-index (HRI) dielectric first layer with a preferably constant thickness, which functions as a waveguide. Optionally, the subwavelength grating may also be provided with a layer sequence consisting of high-refractive-index (H) and low-refractive-index (L) dielectric layers, for example a three-layer system HLH. A subwavelength grating has in particular at least one or one azimuth angle. In the case of a linear grating, there is in particular one distinguished direction along which a sequence of elevations and depressions is provided. The azimuth angle describes the angle at which the lines along which elevations and depressions of the grating follow one another lie in relation to a reference line which extends in the plane out of which the elevations and depressions extend vertically. In the case of a crossed grating, although there are two distinguished directions along which a sequence of elevations and depressions exists, one of these directions can be chosen in order to define the azimuth angle on the basis thereof.

It is thus possible that, in the overlap region, at a particular viewing angle such as the first viewing angle, a defined color and/or brightness is visible which differs from the effect which is visible in the comparison region. This difference may for example highly vivid or striking and can thus improve protection against forgery.

It is possible in particular that, in the second viewing situation, the third color and/or third brightness is visible in the overlap region and in the comparison region, or the third color and/or third brightness is visible in the comparison region and a fifth color and/or fifth brightness is visible in the overlap region. The fifth color and/or fifth brightness is preferably generated by the first optically variable effect or the first security element. The third and/or fifth color and/or brightness is in this case generated in particular by the subwavelength grating for generating non-metallic zeroth order colors and/or brightnesses.

Such light properties are possible in particular by means of a surface structure in the form of cylindrical lenses. Other structures are however also conceivable. For example, it is possible that the surface structure has one or more profile shapes, for example prismatic profile shapes, which extend over the first outer face preferably along a line at the angle of rotation which corresponds to the viewing direction in the second viewing situation, and/or parallel thereto. In the case of cylindrical lenses, this is for example the cylinder axis. Preferably, the at least one relief structure of the first security element has an azimuth angle of a sequence of elevations and depressions, said azimuth angle being perpendicular to said line or extent. In particular, the first viewing situation differs from the second viewing situation by a rotation of the security document, without a change in the viewing angle and without a change in the illumination angle. Preferably, there is an angle of rotation in a range from 20° to 160°, in particular of 90°, between the first viewing situation and the second viewing situation.

The surface structure thus changes in particular the angle of incidence on the first security element, in particular comprising the subwavelength grating for generating non-metallic zeroth order colors and/or brightnesses, and thus the color and/or brightness which is visible in the overlap region, preferably in relation to the same viewing situation in the comparison region. In the overlap region, the visible color and/or brightness thus corresponds in particular to a color and/or brightness which would be visible without the surface structure in the event of tilting to a relatively high or relatively low degree, wherein the visible color and/or brightness is in particular dependent on the structure, which is for example lenticular or prismatic, and on the spacing of said structure to the first security element, in particular comprising the subwavelength grating for generating non-metallic zeroth order colors and/or brightnesses.

In particular if the optically variable effect of the security element is visible in the comparison region in the first view, the reference light property is preferably generated by light which is diffracted in the zeroth order of diffraction by the first security element. In particular if the optically variable effect of the first security element is not visible in the comparison region in the first view, or if the at least one relief structure has a subwavelength grating for generating non-metallic zeroth order colors and/or brightnesses, preferably for generating tilt-angle-dependent and/or azimuth-angle-dependent colors and/or brightnesses, the contrasting light property is preferably generated by light which is diffracted in the zeroth order of diffraction by the first security element.

It is possible that the at least one reflection layer is or comprises an HRI layer which is preferably arranged on the subwavelength grating for generating non-metallic zeroth order colors and/or brightnesses, in particular for generating tilt-angle-dependent and/or azimuth-angle-dependent colors and/or brightnesses. Preferably, the HRI layer comprises or consists of TiO₂ or ZnS. The refractive index of an HRI layer is in particular at least 1.8, preferably at least 2.0. With an HRI layer having a refractive index of 1.8 on a polymer having a refractive index of 1.5, it is for example possible to achieve a reflection of approximately 1%. The HRI layer preferably has a layer thickness in a range from 20 nm to 200 nm. The HRI layer is in particular transparent or semitransparent in the wavelength range which is visible to the human eye.

It is also possible that the at least one reflection layer is or comprises a metallic layer. The metallic layer has in particular a layer thickness in a range from 5 nm to 200 nm. The metallic layer preferably comprises or consists of one or more of the following layers: one or more metal layers consisting of aluminum, copper, silver, indium, palladium, chromium, tin or alloys thereof, one or more lacquer layers comprising metallic pigments or metallic nanoparticles. A reflection layer comprising or consisting of a metallic layer is preferably arranged on the subwavelength grating for generating zeroth order color effects, on the relief structure for generating achromatic lighting-up effects, and/or on the diffraction grating for generating chromatic lighting-up effects.

The at least one reflection layer may, in part or in its entirety, be a thin-film structure, in particular a Fabry-Pérot interference layer structure. Such thin-film structures comprise or consist of in particular at least two metallic layers and preferably a transparent dielectric spacer layer arranged between the metallic layers, wherein preferably at least one of the metallic layers is semitransparent. Here, the semitransparent metal layer or metal layers preferably consist of chromium, silver or aluminum and in particular have an optical thickness in a range between 0.3 OD and 0.8 OD, and preferably in a range between 0.4 OD and 0.6 OD. If an opaque metal layer is provided in the thin-film structure, then in particular the same boundary conditions as for the metallic reflection layer described further above apply to said opaque metal layer. The transparent dielectric spacer layer preferably comprises or consists of one of the following materials: MgF₂, SiO₂, TiO₂ or ZnS. The thickness of the transparent dielectric spacer layer preferably lies in the range from 150 nm to 700 nm.

Product features mentioned above may self-evidently be used equivalently in a method for producing the security document, or method features that have been mentioned may be used in the security document.

The invention will be discussed by way of example below on the basis of a plurality of exemplary embodiments and with reference to the appended drawings. The exemplary embodiments shown are therefore not to be understood as limiting.

FIG. 1a is a schematic illustration of a cross section of a security document,

FIGS. 1b, 1c, 1d, 1e and 1f schematically show a detail of a cross section of a security document,

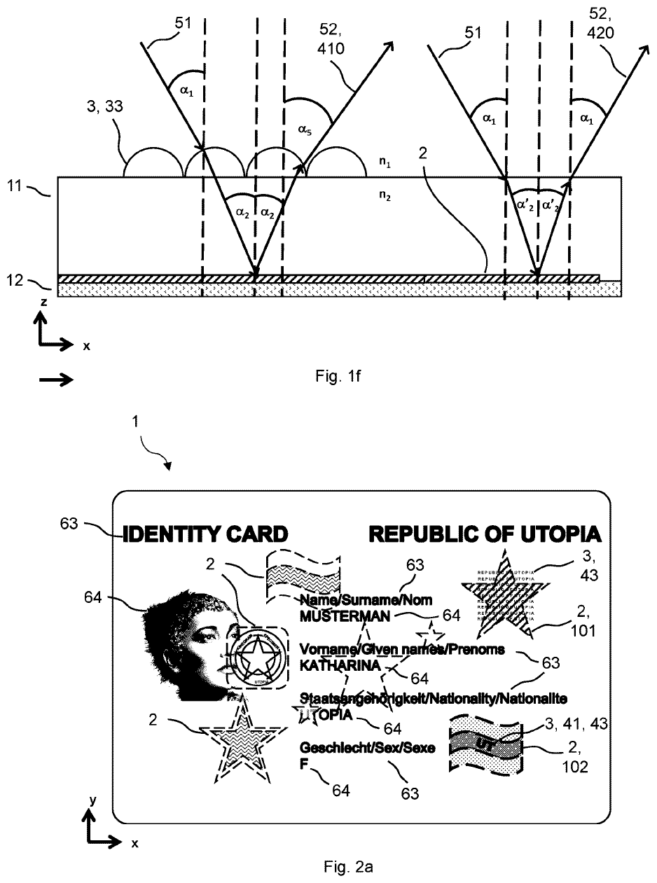

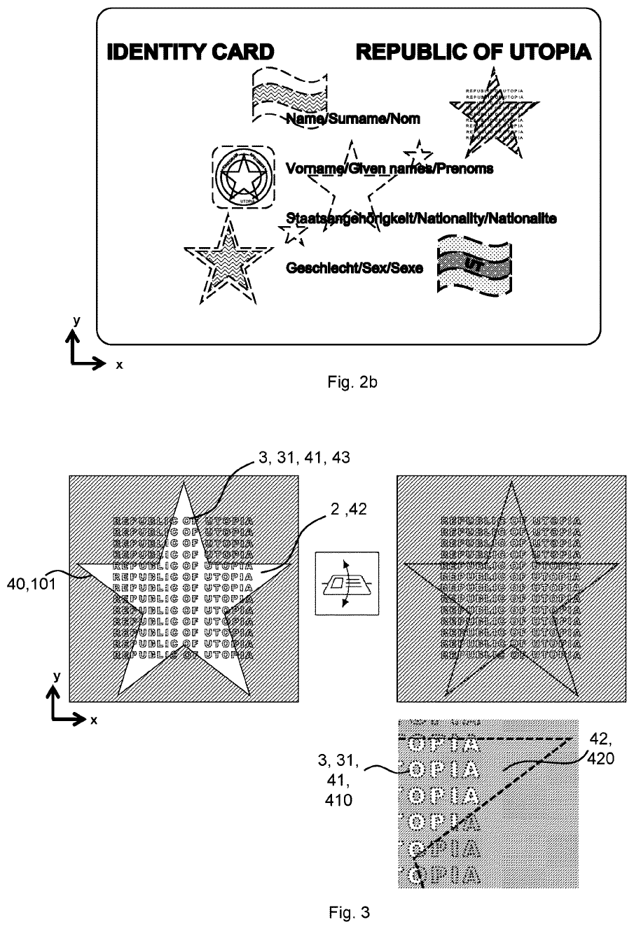

FIGS. 2a and 2b schematically show a plan view of a security document,

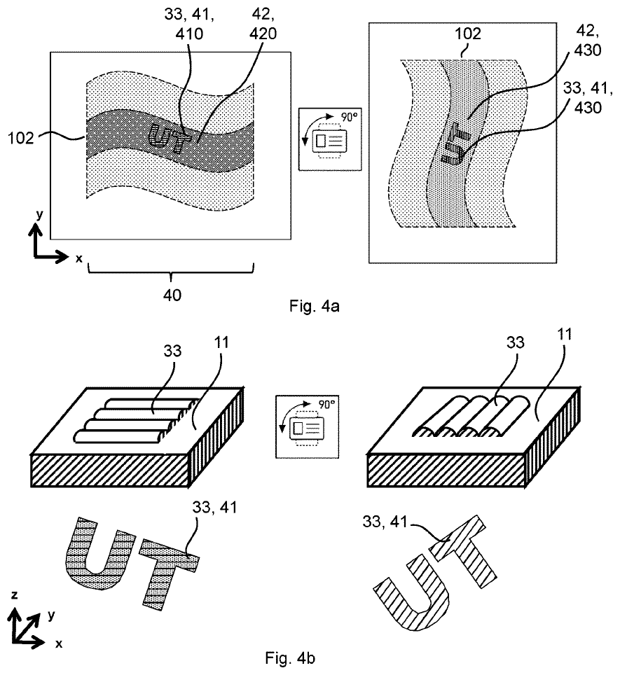

FIGS. 3 and 4a schematically show a detail of a plan view of a security document,

FIG. 4b schematically shows an orientation of the surface structure,

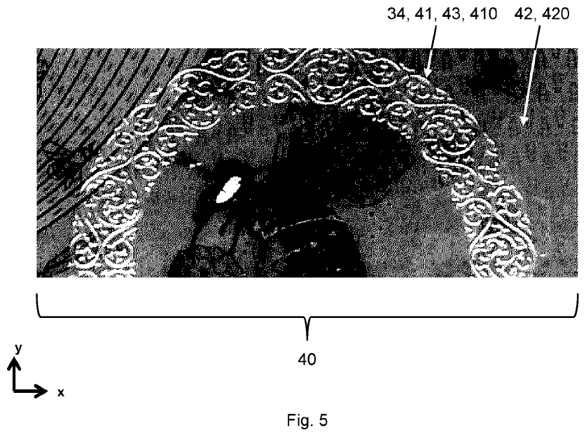

FIG. 5 shows a photograph of a detail of a security document.

FIG. 1a shows, schematically but not true to scale, a cross section through an exemplary security document 1. The security document 1 comprises a first outer face, which in FIG. 1a is visible in particular in a view directed from top to bottom and which may be configured for example as shown in FIG. 2a and FIG. 2b.

Regions, overlaps, widths and lengths are in particular applicable in a plan view, which can be seen in FIG. 2a and FIG. 2b and constitutes a view directed from top to bottom in FIG. 1a. A view directed from top to bottom is in particular a view directed onto the first outer face or a view directed perpendicularly onto a plane spanned by the first outer face. Such a plane is spanned in particular by the x axis and by the y axis. A width may be measured for example along the x axis and/or the y axis. A depth may be measured for example along the z axis.

The security document 1 shown in FIG. 1a is preferably a security document, in particular a card, based on plastics material. A security document 1 based on plastics material preferably consists of a plurality of layers, which are preferably joined together in a lamination process. For this purpose, the method according to the invention may for example be carried out. The total thickness of the security document 1 is preferably configured in accordance with standard specifications. In the case of card-based ID documents (format ID-1), this is in particular approximately 780 μm, in accordance with ISO/IEC 7810:2019.

The individual layers advantageously consist of a similar material, such as polycarbonate (PC) or polyvinyl chloride (PVC), such that, in particular after the lamination process, a stable and approximately homogeneous composite body is created. It is however also possible for different materials to be connected to one another, optionally with the aid of one or more adhesive layers, composed for example of polyurethane, or with the aid a heat-sealable adhesive. Such adhesives may also be post-crosslinking, such that they no longer melt again under the action of heat. For example, one or more layers may also consist of Teslin.

The security document 1 illustrated in FIG. 1a preferably has a substantially opaque core, which commonly has a white pigmentation. The core is formed in particular by the core layer 15. The core layer 15 is preferably arranged centrally and/or at the inside in the security document 1. The core layer 15 is adjoined in particular above and below by transparent layers, in this example the layer 14 and the layer 16. The core layer 15 may also contain transparent zones that can be used as window regions. Not illustrated are optional electronic components, such as an RFID antenna and a chip, which may for example be situated in the core layer 15. The core layer 15 may be assembled from a plurality of layers, and it is possible that the core layer 15 is not constructed from a homogeneous material.

By way of example, FIG. 1a also illustrates a transparent layer which is configured as a personalization layer 12 and which is an absorption layer, in particular in the form of a laser-engravable layer. Preferably, blackening can be performed in the personalization layer 12 of the security document 1, in particular by means of laser radiation, in order to form personalized information items 64. The extent of the blackening may be influenced in particular by the selected laser parameters. As indicated by FIG. 1a, the personalized information item 64 preferably at least partially overlaps the first region 40, that is to say with the optically variable effect, which is visible in a first viewing situation, of the first security element 2. Further personalized information items 64 may also be situated outside the first region 40, such as the “F” shown in FIG. 2a under the printed text “Geschlecht/Sex/Sexe”.

The personalized information items 64 may optionally also be implemented by means of a printing operation, for example onto a layer which is above the first security element 2 in the viewing direction, or directly onto the first security element 2, or onto a layer which is below the security element 2 in the viewing direction, and in particular sealed with further layers by means of lamination, in particular during the pressing-together operation. The viewing direction is in particular directed from top to bottom in FIG. 1a, and may be present in the first viewing situation.

It is also conceivable, instead of the personalization layer 12, to provide a combination of an absorption layer, in particular comprising blackening implemented by laser personalization, with an in particular colored print on a further layer of the security document 1 or on the surface of the security document 1.

The first security element 2 is contained in particular in the form of a patch in the security document 1. A security element 2 in the form of a patch is in particular introduced into the multi-layer structure, for example by being adhesively bonded to the personalization layer 12 or to the transparent layer 14 or to the core layer 15, before the layers of the security document 1 are connected, preferably by lamination. The security element 2 may however also be produced for example directly in or on one of the layers 11, 12, 13, 14, 15 and 16, for example by virtue of a relief structure being directly stamped into a polycarbonate layer and, before or after the stamping, with a coating or, by vapor deposition, with a reflection layer. The first security element 2 is preferably transparent, in particular in a viewing situation which is the first viewing situation or a different viewing situation, in particular a second viewing situation. The security element 2 is situated preferably between the covering layer 11 and the core, in particular the core layer 15, more preferably between the covering layer 11 and an optional printed layer, which is printed preferably by offset printing.

Flexographic printing, gravure printing, screen printing or inkjet printing are also possible as printing methods. The printed layer is in particular a layer printed onto the transparent layer 14, or a layer printed onto the core layer 15.

FIG. 1a shows in particular, by way of example, a security document 1 having a covering layer 11 which is preferably transparent. The covering layer 11 comprises or consists in particular of PC or PVC. In a view directed onto the first outer face, the personalization layer 12 is arranged, in particular arranged so as to be visible, under the covering layer 11. The security document 1 shown in FIG. 1a also has further optional transparent layers 13, 14 and 16, which in particular consist of PC or PVC or comprise PC or PVC. The transparent layer 13 is arranged between the personalization layer 12 and the transparent layer 14. The first security element 2 is arranged between the covering layer 11 and the personalization layer 12. The core layer 15, which is preferably opaque, is arranged under the layer 14. The core layer 15 comprises or consists in particular of PC or PVC. In particular, one or more further transparent layers 16 is or are arranged under the core layer 15. In a view directed onto a second outer face, situated opposite the first outer face, of the security document 1, that is to say from bottom to top in FIG. 1a, it is thus for example the case that the core layer 15, or for example a decorative layer or decorative layers optionally applied to the core layer 15, is or are visible. The layer 16 comprises or consists in particular of PC or PVC. In a preferred embodiment, the layers 11 to 16 all consist of, or the layers 11 to 16 all comprise, PC.

The security document 1 may in particular also have one or more further printed layers. The core layer 15 or one or more of the layers 11 to 14 may for example have one or more printed layers printed thereon. The core layer 15 or the layer 16 may for example also have a printed layer printed thereon, said printed layer being visible in a view directed onto the second outer face. Printing methods used for the one or more printed layers are for example offset printing and/or digital printing, in particular for the graphic design and/or as a security feature, and screen printing, in particular for special effect colors, for example OVI™ or metal pigments.

It is also possible that the security document 1 has a first security element 2 over a full area or in particular over almost a full area, said first security element preferably covering more than 50%, more preferably more than 80%, of the area of the security document 1, preferably of an area which is visible in a view directed onto the first outer face.

In particular, layer sequences other than those described above, and the omission of layers or addition of further layers, are also conceivable.

As illustrated in particular by FIG. 1a, the security document 1 has a first security element 2 having a first optically variable effect in the first region 40. The first security element 2 is preferably arranged between the covering layer 11 and the card core 15, more preferably between the covering layer 11 and the personalization layer 12. In particular, in a view directed onto the first outer face, the security document 1 is transparent at least as far as the first security element 2. For this purpose, the covering layer 11 may for example be formed from a transparent plastics material, preferably polycarbonate.

The security document 1 furthermore has an exposed surface structure 3 arranged on a first outer face of the security document 1. In the example illustrated by FIG. 1a, the surface structure 3 is in particular formed into the covering layer 11. In this example, the surface structure 3 is furthermore formed by a plurality of different types of surface structures. These are in particular a matte structure 31, microprisms 32 and microlenses 33. The microprisms 32 are in particular triangular prisms. The microlenses 33 are in particular cylindrical lenses. It is however possible for the surface structure 3 to have a plurality of different types of surface structure or only a single type of surface structure, for example one structure out of the structures shown in FIG. 1a. It is also possible that the surface structure has types of surface structure other than those shown, for example as discussed with reference to FIG. 5 with regard to the surface structure 34 or with regard to linear elevations and/or linear depressions.

The security document 1 shown in FIG. 1a furthermore has an overlap region and a comparison region. These regions are illustrated in particular by FIG. 1b, which shows the overlap region 41 and the comparison region 42 by way of example. In the overlap region 41, the surface structure 3 overlaps the first security element 2.

The security document 1 furthermore has the comparison region 42, in which the first security element 2 is present but the surface structure 3 does not overlap the first security element 2. The first outer face therefore in particular has no surface structure in the comparison region 42.

The optically variable effect of the first security element 2 is visible in particular in a view directed onto the first outer face, that is to say for example from top to bottom in FIG. 1a, wherein the predefined first viewing situation is present.

It is preferable that, in the first viewing situation, the first optically variable effect of the first security element 2 is visible both in the overlap region 41 and in the comparison region 42, but is visible with different colors and/or different brightnesses, such that a corresponding defined color and/or brightness contrast is evident between the optical image in the overlap region 41 and in the comparison region 42.

It is furthermore preferable that, in the first viewing situation, the optically variable effect of the first security element 2 is not visible in the comparison region 42 and is visible only in the overlap region 41, for example by virtue of the angle of incidence on the security element 2 being set or changed such that, for example, the first order of diffraction of a diffraction grating of the first security element 2 is made visible.

It is also possible that, in the first viewing situation, the optically variable effect is visible either in the overlap region 41 and the optically variable effect of the first security element 2 is not visible in the comparison region 42, for example by virtue of the first security element 2 being transparent in the comparison region 42 in the first viewing situation. It is preferable here if, in the comparison region 2, a defined color and/or defined brightness is present which is generated for example by one or more decorative layers which are for example applied, preferably printed, on one or more layers selected from the covering layer 11, the personalization layer 12, the transparent layer 13, the transparent layer 14 or the core layer 15.

In addition to the possibilities mentioned above, further viewing situations are also conceivable, for example in which the first security element 2 is transparent in the overlap region 41.

FIG. 1b shows, schematically but not true to scale, a detail of a security document 2, for example of the security document 1 shown in FIG. 1a, in particular for the purposes of illustrating the overlap region 41, the comparison region 42 and the surface structure region 43. The surface structure 3, such as the matte structures 31 shown by way of example, are present in particular in the surface structure region 43 of the security document 1.

As illustrated by FIG. 1b, a design 400 is preferably made up of a plurality of design elements which are formed in particular by the surface structure 3, which is shown by way of example in the form of matte structures 31 in FIG. 1b, and the first security element 2. It is possible here that the security document 1 has further designs in other regions. In particular, a design such as the design 400 constitutes a logically coherent image.

In the detail illustrated by way of example in FIG. 1b, a first design element is formed by the illustrated first region 40, a second design element is formed by the illustrated comparison region 42, a third design element is formed by the illustrated overlap region 41, and a fourth design element is formed by the illustrated surface structure region 43. The entire comparison region 42, or at least one or more subregions of the comparison region 42 which in particular together form at least one second design element, preferably exhibit(s) the reference light property preferably over a full area in the first viewing situation. The entire overlap region 41, or at least one or more subregions of the overlap region which in particular together form at least one third design element, preferably exhibit(s) the contrasting light property preferably over a full area in the first viewing situation.

As illustrated by FIG. 1b, the regions 41, 42 and 43 may, in a Cartesian coordinate system having the coordinates x, y and z, be spanned in an x/y plane, wherein the y direction extends perpendicularly to the cross section. Here, the cross section is oriented in particular along a perpendicular to a plane spanned by the first outer face.

In FIG. 1b, an extent of the surface structure 3 runs in the x direction and in the y direction. The extent is in particular applicable to each design element. In other words, the region 43, as shown in particular by FIG. 1b, may form a design element, and it is possible that the surface structure region 43 has a plurality of subregions (not illustrated in FIG. 1b) which form a plurality of design elements in the security document 1. In particular, it is possible that the surface structure 3 comprises a plurality of mutually separate design elements. Here, “mutually separate” means in particular that at least 0.5 mm, preferably at least 2 mm, more preferably at least 5 mm, of the first outer face without a surface structure 3 is present between the design elements, in particular in a view directed perpendicularly onto the plane spanned by the first outer face, which in FIG. 1b is for example a view directed from top to bottom.

Typically, the extent of a design element of the surface structure 3 in a view directed perpendicularly onto a plane spanned by the first outer face, in particular in the x and y directions in FIG. 1b, lies in a range of 100 μm and 50 mm, preferably between 200 μm and 30 mm and more preferably between 300 μm and 20 mm. Preferably, the region 43 or the subregions of the region 43 having the surface structure 3 is or are in the form of icons or motifs or geometrical shapes that are visible to the human eye.

As illustrated by FIG. 1b, the first security element 2 preferably also lies in the x/y plane, but at a different height in the z direction than the surface structure 3, in particular further into the interior in the security document 1. In this case, too, the extent is in particular applicable to each design element. It is thus possible that the security element 2 forms a design element or is arranged in a plurality of subregions of the region 40 which form a plurality of design elements (not illustrated in FIG. 1b). In particular, it is possible that the first security element 2 comprises a plurality of mutually separate design elements. Here, “mutually separate” means in particular that at least 0.5 mm, preferably at least 2 mm, more preferably at least 5 mm, without the first security element 2 is present between the design elements, in particular in a view directed perpendicularly onto the plane spanned by the first outer face, which in FIG. 1b is for example a view directed from top to bottom.

Typically, the extent of a design element of the first security element 2 in a view directed perpendicularly onto a plane spanned by the first outer face, in particular in the x and y directions in FIG. 1b, lies in a range from 100 μm to 50 mm, preferably in a range from 200 μm to 30 mm and more preferably in a range from 300 μm to 20 mm.

The overlap region 41 is preferably also in the form of motifs, such as icons or geometrical shapes, which are visible to the human eye.

The first security element 2 and the surface structure 3 at least partially overlap. The overlap region 41 has in particular an extent in the x direction and an extent in the y direction. Preferably, the extent of the overlap region 41 at least in one of the two directions x and y is at least 3 mm, more preferably at least 6 mm and particularly preferably at least 10 mm. These minimum extents furthermore preferably apply in both spatial directions. The extent of the overlap region 41 particularly preferably amounts to an area of at least 1 mm×1 mm, more preferably at least 2 mm×2 mm, more preferably at least 3 mm×3 mm.

The first security element 2 is furthermore arranged in the comparison region 42, which does not overlap the surface structure 3. Said comparison region 42 does not exhibit the contrasting light property arising from the surface structure 3, and functions as a reference for the human eye, which is very good at perceiving brightness contrasts and/or color contrasts. The extent of this comparison region 42 has in particular an extent in the x direction and in the y direction. Preferably, the extent of the comparison region 42 at least in one of the two directions x and y is also at least 3 mm, more preferably at least 6 mm and particularly preferably at least 10 mm. These minimum extents furthermore preferably apply in both spatial directions. The extent of the comparison region 42 particularly preferably amounts to an area of at least 1 mm×1 mm, more preferably at least 2 mm×2 mm, more preferably at least 3 mm×3 mm. This ensures that the brightness difference and/or color difference of the optical effect of the first security element 2, said difference being caused by the surface structures, is clearly perceptible to the human eye.

Preferably, in the first region 40, the first security element 2 comprises at least one replication layer having at least one relief structure, and comprises at least one reflection layer, wherein the reflection layer is arranged on the at least one relief structure. In particular, the at least one relief structure comprises a first relief structure which is present both in the overlap region 41 and in the comparison region 42, and/or the first relief structure extends, at least in parts, uninterruptedly from the overlap region 41 into the comparison region 42. It is possible that the first region 40 is a closed region or, for example in order to form the aforementioned design, is made up of a plurality of preferably separate subregions, which have the first relief structure and/or one or more further relief structures. Owing to the surface structure 3, it is possible, in particular despite an identical relief structure, in particular of a design, being arranged both in the overlap region 41 and in the comparison region 42, for different colors and/or brightnesses to be cast into the eye of a viewer in the first region 40.

With regard to possible configurations of the first security element 2 and in particular of the at least one relief structure, reference is made in particular to the statements above. Profile shapes of relief structures are in particular applicable in a cross-sectional view, as illustrated by FIGS. 1a to 1f. Shapes of relief structures, such as linear, cruciform, hexagonal or pseudorandom, relate in particular to a plan view, that is to say for example a view directed along the z axis.

For example, it is possible that the first security element 2 and/or the optically variable effect of the first security element 2 provides one or more of the following colors and/or brightnesses and/or properties in the overlap region 41 and/or the comparison region 42:
at least a first color and/or first brightness, which is generated by the optically variable effect and is visible in the first viewing situation and optionally also in a second viewing situation in the overlap region 41 and preferably forms the contrasting light property;
at least a second color and/or second brightness, which is generated by the optically variable effect and is visible in the first viewing situation in the comparison region 42 and preferably forms the reference light property;
at least a third color and/or third brightness, which is generated by the optically variable effect and is visible in the second viewing situation in the comparison region 42;
a transparency in the comparison region 42, such that, in the first or second viewing situation, a fourth color and/or fourth brightness, which is not generated by the optically variable effect, is visible in the comparison region. The fourth color and/or fourth brightness may instead be generated for example by one or more decorative layers, such as one or more printed layers.

The first and second viewing situations are preferably mutually different viewing situations.

Here, preferably the same optical effect of the security element 2 is provided in the overlap region 41 and in the comparison region 42, but the surface structure 3 is coordinated with the optically variable effect of the first security element 2 such that the defined color difference and/or defined brightness difference is generated at least in the first viewing situation. In particular, the contrasting light property corresponds to the first color and/or first brightness, and the reference light property corresponds to the second color and/or second brightness and/or corresponds to the fourth color and/or fourth brightness.

Preferably, the first color and/or first brightness and in particular also the second color and/or second brightness is formed by a zeroth order color effect of the optically variable effect of the first security element 2.

FIGS. 1c, 1d and 1f illustrate in particular a change of the light by the surface structure 3. In a defined viewing situation such as the first viewing situation, visible light properties such as the contrasting light property 410 and the reference light property 420 may be visible in particular in the form of mutually parallel light rays.

FIG. 1c shows a detail for schematically illustrating the optical effects of the security document 1 having a surface structure 3, which is shown by way of example in the form of a matte structure 31. As is schematically indicated by FIG. 1c, a reference light property 420 is visible in the comparison region 42 in a first viewing situation. The reference light property 420 is a defined color and/or brightness, in particular the second color and/or second brightness. The reference light property 420 is preferably visible over the entire comparison region 42 or at least in one or more subregions of the comparison region 42 which form a design element. Here, the matte structure 31 is configured such that, in the first viewing situation, said matte structure causes a change in light 52 which is radiated from the first security element 2 in the overlap region 41. Thus, in the view in which the reference light property 420 is visible in the comparison region 42, a contrasting light property 410, which is a defined color and/or brightness and which is generated by the first optically variable effect of the first security element 2, is visible in the overlap region 41. In the exemplary illustration, the radiated light 52 is expanded, with the result that, in the first viewing situation, there is a brightness difference in relation to the reference light property 420 if the optically variable effect of the security element is visible both in the overlap region 41 and in the comparison region 42, or, for the first viewing situation, a viewing angle can be selected in the case of which the optically variable effect of the security element 2 is visible only in the overlap region 41, as will in particular be described in more detail further below.

The matte structure 31 in particular also already expands the light which is incident on the security document 1, such that the light 51 which is incident on the security element 2 has been expanded. The expansion of the light which is incident on the security element 2 may be defined in particular by an angle 61, as shown in FIG. 1c.

In the case of color effects which are dependent on the angle of incidence, for example in the case of metallized subwavelength gratings or subwavelength gratings coated with an HRI layer, the incident light 51 that has been expanded with an angle β₁ causes the color of the emergent light 52 to also be changed. In particular, the greater the scattering intensity of the matte structure 31, the more pronounced this color change is. In the case of an anisotropically scattering matte structure, this color change is preferably observable only in one spatial direction, in particular in the spatial direction in which the anisotropically scattering matte structure causes more intense scattering, said spatial direction being transverse to the privileged direction of the anisotropically scattering matte structure. The “color change” may in particular be understood to mean a color difference in relation to the case where no surface structure is present, wherein this preferably corresponds to the conditions in the comparison region.

The expansion of light 52 which is radiated from the first security element 2 may be defined in particular by an angle β₂, as shown in FIG. 1c. The angle is measured in particular proceeding from a light ray which exits the security document 1 without the surface structure 3, for example in the comparison region 42. If an isotropically scattering matte structure is provided, which is a preferred matte structure, then the angle is for example expanded uniformly in all directions proceeding from a light ray which exits the security document 1 without the surface structure 3. The light exiting at the surface structure 3 may be expanded by the matte structure 31 for example with an angle β₂ in a range from 0.5° to 45°, preferably from 2° to 30°, and particularly preferably from 2° to 15°.

The matte structure 31 expediently has an average spacing of randomly or pseudorandomly varying elements in a range from 1 μm to 100 μm, preferably in a range from 5 μm to 50 μm. The spacing of the elements may be understood in particular to mean a spacing of maxima, in particular in a roughness profile, as can be seen in particular in a cross section illustrated by FIG. 1c. It is also expedient if the matte structure 31 has a structure depth in a range from 0.5 μm to 20 μm, preferably from 1 μm to 10 μm. The structure depth is in particular the spacing from a maximum to a minimum, in particular in a roughness profile. It is thus possible in particular to achieve high scattering efficiency of the light 52 which is diffracted and/or reflected and/or scattered from the first security element 2 to the surface structure 3 and which exits the security document 1 again through the surface. By means of the stated parameters, it is possible in particular to targetedly set the expansion and thus in particular set the defined color difference and/or brightness difference.

The contrasting light property 410 thus differs from the reference light property 420 by a defined brightness and/or color difference, in particular owing to a reduction in the brightness caused by the expansion. By virtue of this difference being defined, it is for example possible to identify forgery on the basis of a deviation from this difference.

It is also possible that the first viewing situation is implemented with a viewing angle in that, owing to the expansion in the overlap region 41, the optically variable effect of the security element 2 generates the visible contrasting light property 410, wherein the optically variable effect of the security element 2 is however not visible in the comparison region 42, and, for example, the reference light property 420 is the fourth color and/or fourth brightness, wherein the security element 2 preferably appears transparent.

In particular, it is possible that the security element 2 is or comprises for example a grating for generating achromatic lighting-up effects, and the matte structure 31 is configured such that, in the first viewing situation, the contrasting light property 410 exhibits an achromatic effect, wherein the reference light property 420 which is visible in the comparison region 42 does not exhibit the achromatic effect in the first viewing situation, since the first viewing situation is implemented within an angle range in which only the light which is expanded by means of the matte structure 31 is visible, not the light which is radiated from the first security element 2 in the comparison region 42. Here, the first security element 2 may be transparent, and the comparison region 41 may for example exhibit a reference light property which in particular corresponds to the fourth color and/or fourth brightness, that is to say said comparison region is formed preferably by one or more decorative layers, for example printed layers, which are provided in the security document 1 and which are preferably situated under the security element 2 in the viewing direction. It is alternatively possible that, in the first view, the achromatic effect is visible both in the overlap region 41 and in the comparison region 42, wherein a lower brightness is however present in the overlap region 41 owing to the expansion by the matte structure 31. In this way, too, it is possible to set a defined color difference and/or brightness difference.

FIG. 1d shows a detail for schematically illustrating the optical effects of the security document 1 having a surface structure in the form of microprisms 32. The microprisms 32 are in particular triangular prisms. As is schematically indicated by FIG. 1d, a reference light property 420, which is a defined color and/or brightness, is visible in the comparison region 42 in a first viewing situation. Here, the microprisms 32 are configured such that, in the first viewing situation, the microprisms 32 cause, in the overlap region 41, a change in light 51 which is incident on the first security element 2. Thus, in the view in which the reference light property 420 is visible in the comparison region 42, a contrasting light property 410, which is a defined color and/or brightness and which is generated by the first optically variable effect of the first security element 2, is visible in the overlap region 41. In the exemplary illustration, the light 51 which is incident on the security element 2 is changed by the microprisms 32 by virtue of the angle of incidence on the security element 2 being changed. The light which is changed by the surface structure 3 which for example comprises or consists of the microprisms 32, and in particular light which is incident on the security element 2 in the overlap region 41, has for example the angle of incidence α₂. By contrast, in the comparison region 42, light is incident on the security element 2 at the angle α′₂. Since the security element 2 has an optically variable effect, the change in the incident light caused by the surface structure 3, for example the microprisms 32, thus results in particular in different colors and/or brightnesses in the regions 41 and 42, which are preferably generated by the optically variable effect of the security element 2 and preferably exhibit the first color and/or first brightness and in particular the second color and/or second brightness. The contrasting light property 410 thus differs from the reference light property 420 by a defined color difference and/or a defined brightness difference.

The angle difference |α′₂−α₂| is preferably at least 2°, in particular at least 4°, preferably at least 6°, preferably at least 8°, more preferably at least 12°. The lateral extent of the microprisms 32 lies in particular in a range from 5 μm to 200 μm, preferably in a range from 10 μm to 100 μm. The depth of the microprisms lies preferably in a range of 1 μm and 40 μm, preferably between 10 μm and 25 μm. A lateral extent of the microprisms 32 refers here in particular to the width exhibited by a prism for example in the x direction in FIG. 1d. The depth extends here in particular in the z direction.

FIG. 1d shows, on the right-hand side, that is to say in particular in the comparison region 42, the incidence of light on an unstructured surface, by means of which the light 51 which is incident on the security document 1, in particular on the covering layer 11, at an angle of incidence α₁ is refracted at the angle α′₂ in the covering layer 11. The refraction occurs in accordance with the law of refraction n₁*sin α₁=n₂*sin α′₂, where n₁ is in particular the refractive index of air and n₂ is in particular the refractive index of the covering layer 11, preferably of a polymer used for said covering layer. In this example, the security element 2 exhibits in particular a zeroth order color effect in the overlap region 41 and in the comparison region 42. In this situation, the reflection angles following the structure and following the point of exit from the covering layer 11 are preferably identical. In particular, the angle α₂ of the light 52 which is radiated from the security element 2 within the covering layer 11 in the overlap region 41 is identical to the angle α₁ of the light 52 which exits the covering layer 11 in the comparison region 42. In particular, in other words, in the situation illustrated by FIG. 1d, the reflection angle of light 51 which is incident on the security document 1 in the comparison region 42 is identical to the exit angle of light 52 which exits the security document 1. The emergent light 52 consequently exits the security document 1, in particular the covering layer 11, at an angle α₁ in the comparison region.

By contrast to the comparison region 42, it is shown on the left-hand side in FIG. 1d, that is to say in particular in the overlap region 41, what occurs when light is incident at the same angle of incidence α₁ on a microprism, here for the special case of perpendicular incidence on the microprism α₁=θ, where θ is the flank angle of the microprism or of the microprisms. In this special case, the light is in particular not refracted by the microprism, and the angle α₂ in the covering layer 11 is therefore identical to the angle of incidence α₁. Said angle α₂ (α₁=θ=α₂) is in this case greater than the angle of incidence α′₂ in the comparison region 42 with the unstructured surface of the covering layer 11. If the color effect is dependent on the angle of incidence, which applies for example in the case of zeroth order color effects, such as are exhibited in this example in particular by the first security element 2, the color which is reflected by the security element 2 in the overlap region 41 is advantageously different, and in particular is visible at a different angle α₄, which can be calculated in accordance with the following formula.

$${n}_{2} sin ( {α}_{1} + θ ) = {n}_{2} sin ( 2 {α}_{1} ) = {n}_{1} sin {α}_{3} = {n}_{1} sin ( {α}_{4} + {α}_{1} )$$

That is to say:

$${n}_{2} sin ( 2 {α}_{1} ) = {n}_{1} sin ( {α}_{4} + {α}_{1} )$$

In the case of small angles (paraxial approximation), sin α≈α, and the following applies:

$${n}_{2} 2 {α}_{1} = {n}_{1} ( {α}_{4} + {a}_{1} )$$

That is to say:

$${α}_{4} = {α}_{1} ( \frac{2 {n}_{2}}{{n}_{1}} - 1 ) = θ ( \frac{2 {n}_{2}}{{n}_{1}} - 1 )$$

The angle α₄ in particular differs from the angle α₁, which in particular in the example illustrated in FIG. 1d corresponds, in the comparison region 42, to the angle of incidence of the light which is incident on the security document 1 and/or to the exit angle of the light exiting the security document 1.

In a case of diffuse illumination and/or illumination by means of a plurality of light sources, it is nevertheless possible for the overlap region 41 and the comparison region 42 to be observed simultaneously, because in these cases the light is incident at a plurality of angles of incidence. In other words, it is possible in particular for a color effect produced by the first security element 2, which is preferably a zeroth order color effect, to be observed both in the overlap region 41 and in the comparison region 42, in particular in the case of diffuse illumination and/or illumination by means of a plurality of light sources, wherein a defined color difference and/or brightness difference is caused by the surface structure 3, for example the microprisms 32.

FIG. 1e shows, by way of example, what occurs in particular when light is incident on a microprism for a more general case with a general angle of incidence (α₁≠θ). In this general case, the light is refracted by the microprism and, accordingly, the angle α₂ in the covering layer 11 is determined in particular as a function of α₁ in accordance with the general formula:

$${n}_{1} sin ( {α}_{1} - θ ) = {n}_{2} sin ( {α}_{2} - θ )$$

That is to say:

$${α}_{2} = {sin}^{- 1} \{ \frac{{n}_{1}}{{n}_{2}} sin ( {α}_{1} - θ ) \} + θ$$

In this general case, it is in particular thus also true that the angle α₂ in the covering layer 11 is changed in relation to the unstructured surface, that is to say in particular in relation to the angle α′₂ in the comparison region 42. Accordingly, it is thus also the case here that color effects which are dependent on angle of incidence, such as zeroth order color effects, change the color impression for a viewer. The color reflected by the security element 2 is thus in particular different, and in particular visible at a different angle α₄, which can be calculated in accordance with the following formula:

$$sin ( {α}_{2} + θ ) {n}_{2} = sin ( {α}_{4} + θ ) {n}_{1}$$

For small prism angles and angles of incidence, in a paraxial approximation, the following in particular thus applies:

$$( {α}_{2} + θ ) {n}_{2} = ( {a}_{4} + θ ) {n}_{1}$$

$${α}_{4} = ( \frac{{n}_{2}}{{n}_{1}} ( {α}_{2} + θ ) ) - θ$$

FIG. 1f shows a detail similar to FIG. 1d, with the difference that a surface structure 3 in the form of microlenses 33, in particular cylindrical lenses, is present instead of the microprisms. As illustrated by FIG. 1f, such microlenses 33 can also be suitable for changing light 51 which is incident on the first security element 2, in particular the angle of incidence α₂ of said light, preferably in relation to the angle α′₂. Accordingly, it is thus also the case here in particular that angle-dependent color effects, such as zeroth order color effects, change the color impression for a viewer. The color reflected by the security element 2 is thus different, and visible at a different angle as. In other words, in the overlap region 41, the color is in particular changed in relation to the color in the comparison region 42. The angle α₅ in particular differs from the angle α₁, which corresponds, in the comparison region 42, to the angle of incidence of the light which is incident on the security document 1 and/or to the exit angle of the light exiting the security document 1.

It is also possible that the microlenses 33 are spherical microlenses, for example in a square or hexagonal arrangement. The microlenses 33 preferably have a lateral extent and/or a diameter which lies in a range of 20 μm and 400 μm, and more preferably in a range of 40 μm and 300 μm. The microlenses 33 preferably have a depth in a range from 5 μm to 40 μm, preferably in a range from 10 μm to 25 μm. A lateral extent of the microlenses 33 refers here in particular to the width exhibited by a lens for example in the x direction in FIG. 1f. The depth extends here in particular in the z direction.

A cross section which is not illustrated but which is also possible is a surface structure 3 which comprises or is linear elevations and/or linear depressions. The lateral extent of the linear elevations and/or depressions runs transversely to the line direction and lies preferably in a range from 10 μm to 300 μm and more preferably from 20 μm to 200 μm. The depth of the linear elevations and/or depressions typically lies in a range from 5 μm to 40 μm and preferably in a range from 5 μm to 25 μm. The linear elevations and/or depressions may be rectilinear and/or also curved. It is also possible for the linear elevations and/or depressions to be both rectilinear in parts and curved in parts. In particular, they may assume the form of alphabetic characters and texts. They may however also, as shown in particular in FIG. 5, constitute patterns such as ornaments. Linear elevations and/or depressions extend, in particular so as to follow a line or so as to follow a plurality of lines, with a cross-sectional profile shape which, along the line(s), is constant at least in parts and/or continuously changes at least in parts. The profile shape of the linear elevations and/or depressions is or comprises in particular one or more of the following profile shapes: binary, parabolic, semicircular, polygonal, triangular, that is to say in particular linearly downwardly sloping, symmetrically triangular, asymmetrically triangular. The profile shape may in particular be selected in accordance with the desired effect on the light which is incident on the security document, in particular the first security element, and/or on the light which is radiated from the first security element, and/or on the light which exits the security document. It is for example possible that, in the first view, rectangular profiles at the edges light up, and/or continuous profiles such as blaze gratings, prisms or microlenses take effect.

The total color difference dE of the contrasting light property 410 and the reference light property 420, as illustrated in particular by FIGS. 1c, 1d and 1f, lies preferably in a range from 3 to 270, preferably in a range from 5 to 270, preferably in a range of 10 to 270. The total color difference is measured in particular in the CIELAB color space. In this regard, reference is made in particular to the statements made above.

As illustrated in particular by FIGS. 1c, 1d, 1e and 1f, it is possible that the change in light 51 which is incident on the first security element 2 (angle of incidence) and/or in light 52 which is radiated from the first security element 2 (angle of emergence), in particular in relation to light which is incident on and/or radiated from the first security element 2 in the comparison region 42, is or comprises one or more of the following changes: a variation of the angle of emergence, in particular increase of the angle of emergence, decrease of the angle of emergence, expansion of the angle of emergence and/or focusing of the angle of emergence, a variation of the angle of incidence, in particular increase of the angle of incidence, decrease of the angle of incidence and/or focusing of the angle of incidence.

FIG. 2a schematically shows a plan view of an exemplary security document 1. The layer structure may be configured as described by way of example with regard to one of FIGS. 1a to 1f. As illustrated by FIG. 2a, it is possible for the security document 1 to have pre-printed information items 63 such as “Surname” or “Given names”. These may be formed for example by a printed layer which is applied in particular before the lamination process. It is also possible for the preprinted information items 63 to be formed into the personalization layer 12 by means of a laser before or after a lamination process. It is also possible for the security document 1 to have a security print, but this is not illustrated in FIG. 2a.

Furthermore, the security document 1 illustrated by FIG. 2a has personalized information items 64. These may for example be a portrait, a surname, a sex or the like, as illustrated by FIG. 2a. Such personalized information items 64 are formed preferably by blackening, in particular under the security element 2 and at least partially overlapping the security element 2. For this purpose, the personalization layer 12 is for example worked by means of a laser. As illustrated by FIG. 2b, a security document 1 that has no personalized information items 64 is also possible. In particular, however, personalization regions are provided, which are intended for the insertion of personalized data such as the personalized data 64 illustrated in FIG. 2a.

The security document 1 illustrated by FIG. 2a and FIG. 2b has, in particular, the first security element 2, which is preferably arranged in a plurality of subregions such that a plurality of designs are formed in the security document by means of the first security element 2, as illustrated by way of example in the form of flags and stars in FIG. 2a. The security element 2 is preferably incorporated by lamination, as is in particular shown in and described with regard to FIG. 1a. In particular, in a view directed onto the first outer face, the security element 2 is situated in front of the personalization layer 12. In this example, in the large star 101 at the top right, the first security element 2 comprises an in particular areal, achromatic lighting-up effect based on a blaze grating having a grating period of approximately 6 μm in combination with a high-refractive-index reflection layer composed of ZnS. Furthermore, in the flag shape at the bottom right, the security element 2 has an in particular areal zeroth order color effect based on linear subwavelength gratings in combination with a high-refractive-index coating (HRI layer) composed of ZnS, as is described in more detail in particular with regard to FIG. 4a. In other words, in the flag, the security element 2 comprises in particular the subwavelength grating for generating non-metallic zeroth order colors and/or brightnesses.

On the first outer face, onto which, in particular, the view is directed in FIGS. 2a and 2b, the security document 1 illustrated in FIG. 2a and FIG. 2b furthermore has the surface structure 3. By way of example, in a subregion of the surface region 43 at the star 101 (top right), the surface structure 3 is provided in the form of microtext, that is to say, in particular, a subregion of the surface region 43 and of the overlap region 41 may, in a first design, be provided in the form of microtext. In the surface structure region 43, the surface structure 3 is formed in particular by matte structures 31, as described for example with regard to FIG. 1b and FIG. 1c.

Furthermore, for example in the region of the flag (bottom right), the surface structure 3 is formed by cylindrical microlenses 33. The cylindrical microlenses 33 are in this case present in the form of a subregion of the surface region 43 and a subregion of the overlap region 41, in the form of the two alphabetic characters “UT”. It is thus possible for a subregion of the overlap region 41 to be formed in a second design, for example in the form of the alphabetic characters “UT”.

FIG. 3 shows, by way of example, a schematic plan view of a region of a security document 1, in particular of the first outer face, having the first security element 2 and the surface structure 3, which in particular forms the first design, at two different viewing angles. In particular, the different viewing angles may be assumed by virtue of the security document 1 being tilted, in particular tilted forward/backward or tilted left/right.

Here, the surface structure 3 is preferably the matte structure 31, and is motif-shaped, specifically in particular in the form of microtext in the surface structure region 43. The overlap region 41 is in this case by that region of the surface structure region 43 which overlaps the first region 40. In this example, within the contour of the star, the first security element 2 has a preferably areal, in particular achromatically lighting-up effect based on a blaze grating, as described for example with regard to FIG. 2a and FIG. 2b. The left-hand image in FIG. 3 shows in particular a normal view. In the normal view, that is to say in a legible orientation of the security document 1, that is to say preferably a combination of illumination angle and viewing angle in the case of which the light diffracted by the blaze grating in regions without the surface structures catches the eye of the viewer, the entire subregion of the first region 40 having the security element 2, which is shown here by way of example as the star 101, lights up brightly. This is the case in particular irrespective of whether or not the surface structure 3, such as in this case the matte structures 31 in the overlap region 41, are situated over said subregion having the first security element 2. The surface structure 31 in the form of the microtext is also brightly highlighted by the lighting-up star in the overlap region 41, that is to say, in the normal view, the microtext in the overlap region 41 is also bright. It is conceivable here for a defined color difference and/or brightness difference to exist between the overlap region 41 having the matte structure 31 in the form of the microtext and the rest of the security element 2 in the form of the star in the comparison region 41, in particular owing to an expansion, described with regard to FIG. 1c, of the light exiting the security document 1, such that this view can correspond to the first viewing situation. In particular, here, the matte structure 31 has the effect that a lower brightness is visible in the overlap region 41 than in the comparison region 42. For this purpose, use may expediently be made of relatively intensely scattering matte structures.

On the right in FIG. 3, a view is shown which may preferably correspond to the first viewing situation. Here, the security document 1 has been tilted relative to the normal view. The lower image shows a further enlarged region in the case of the tilted view. Here, in relation to the view in the left-hand image, the security document 1 has been tilted such that the achromatically diffracted light is no longer directed, in particular diffracted, into the eye of the viewer in regions without the matte structure 31, that is to say outside the overlap region 41 in the form of the microtext. By contrast, in the overlap region 41 having the surface structure 31 and the first security element 2, that is to say in this case the star 101, for example, the achromatic effect remains visible as a result of the fanning-out of the diffracted light owing to the interaction with the matte structures 31. Thus, in this example, that part of the matte structure 31 or of the microtext having the matte structure 31 which is arranged over the first security element 2 or the star 101 remains in an angle range around the diffraction angle of the achromatic grating (as previously in the case of the normal view), as is schematically illustrated in the image on the right-hand side. At the same time, however, the remaining area of the star 101 outside the matte structure 31 or the microtext no longer lights up brightly, or is darker than the regions of the microtext. It is consequently possible to provide a defined brightness and/or color difference.

It is also possible that either the viewing situation shown on the left or the viewing situation shown on the right constitutes the second viewing situation, in particular such that the security document in the first viewing situation exhibits a defined interaction in relation to the second viewing situation, by virtue of the fact that, in the first viewing situation, the contrasting light property constitutes a defined color and/or defined brightness, which is also present in the second viewing situation at least in the comparison region and/or both in the comparison region and in the overlap region, in particular like the achromatic effect illustrated by FIG. 3.

FIG. 4a shows, by way of example, a schematic plan view of a region of a security document 1 having the first security element 2 and the surface structure 3, at two different viewing angles. In particular, the different viewing angles may be assumed by rotating the security document 1. The region illustrated by FIG. 4a may for example be a first region 40 as shown in FIG. 2a and FIG. 2b, or a subregion thereof, having the security element 2 in the form of a flag, which is illustrated on an enlarged scale by FIG. 4a. This region and the region illustrated by FIG. 3 may each be present individually or in combination with one another and/or with further regions having the security element 2 and/or the surface structure 3, in particular with an overlap region 41 and/or a comparison region 42, in one security document.

It is possible that a region 40 of the security element 2, as illustrated in FIG. 4 by a flag, has a preferably areal zeroth order color effect based on linear subwavelength gratings, which is in particular the subwavelength grating for generating non-metallic zeroth order colors and/or brightnesses and preferably a subwavelength grating for generating azimuth-angle-dependent colors and/or brightnesses. With regard to the configuration, reference is also made in particular to the statements above. In the flag illustrated by FIG. 4, the optically variable effect of the first security element 2 is present in the middle band 102 of the three bands of the flag. In particular, in the middle band 102, the security element 2 comprises the subwavelength grating for generating azimuth-angle-dependent colors and/or brightnesses. The two other bands of the flag optionally have, for example, an isotropically scattering matte structure, and thus appear white or light gray at virtually all viewing angles.

The surface structure 3 is present in the overlap region 41, said surface structure being formed in this example by microlenses 33 which are cylindrical and which are arranged in a motif-shaped region which in FIG. 4 forms, by way of example, the alphabetic characters “UT”. A view of the security document 1 at an angle of rotation of 0° is shown on the left, and a view at an angle of rotation of 90° is shown on the right.

Here, the period of the subwavelength grating is in particular 380 nm, and the grating depth is 150 nm. In particular, zinc sulfide ZnS having a thickness of 80 nm preferably forms the reflection layer situated on the subwavelength grating, said reflection layer preferably being embedded in a polymer having a refractive index of approximately 1.5, thus forming, in particular, the HRI layer.

In particular in the case of a legible orientation of the security document 1, at an illumination angle and viewing angle of approximately 25° with respect to the normal to a plane spanned by the first outer face (which in this case is preferably referred to as a normal view), the middle band 102 of the flag appears for example in an orange-red color in the comparison region 42 outside the “UT” if grating lines of the linear subwavelength grating extend in the y direction. A rotation of the security document 1 may be 0° in this case. The superposition with the microlenses 33 causes a color change and/or brightness change to green to occur within the region of the “UT”. In other words, in the overlap region 41, the contrasting light property is green.

In particular, it is possible that, if the security document 1 is rotated through a predetermined angle, for example through 90°, and at the same time a constant illumination angle and viewing angle of approximately 25° with respect to the normal to a plane spanned by the first outer face are maintained, the color and/or brightness of the security element 2, in particular of the middle band 102 as shown in FIG. 4a, changes both in the overlap region 41 and in the comparison region 42 from one predefined color and/or brightness to another predefined color and/or brightness.

In the example of FIG. 4a, the color in the middle band 102 preferably changes from orange-red to green. If an overlap region 41 is now present, as illustrated by way of example in FIG. 4a by way of cylindrical microlenses 33 (also referred to as lenticular lenses) in the region having the form of the alphabetic characters “UT”, then it is possible to design the microlenses 33 so as to achieve a defined brightness and/or color difference, which is dependent on the orientation of the cylindrical microlenses 33, of the zeroth order color effect generated by the subwavelength grating. As shown in the left-hand image in FIG. 4a, this difference exists between the contrasting light property 410, which is visible in the overlap region 41, and the reference light property 420, which is visible in the comparison region 42. It is thus possible that the left-hand image in FIG. 4a shows, in the overlap region 41, a first viewing situation, wherein a contrasting light property 410, for example the color green, which is generated by the security element 2, is visible in the overlap region 41 and a reference light property 420, for example the color orange-red, which is also generated by the security element 2, is visible in the comparison region 42. Here, the security element 2 is in particular of identical form in the overlap region 41 and in the comparison region 42, and the different colors and/or brightnesses are generated by the change in the light at the surface structure 3.

By rotating the security document 1, the security document 1 can then be brought into a second viewing situation, in which a third light property 430 is visible both in the overlap region 41 and in the comparison region 42. The third light property 430 is in particular the third color and/or third brightness. It is also conceivable that, in the second viewing situation, the third color and/or brightness is present in the comparison region 42, whilst the fifth color and/or fifth brightness, which in particular differs only slightly from said third color and/or brightness, is present in the overlap region 41. Here, the rotation from the first viewing situation into the second viewing situation involves for example an angle of rotation of 90°, though this may preferably lie in a range from 20° to 160°.

The orientation of the cylindrical microlenses 33 in the two situations shown in FIG. 4a is illustrated schematically and by way of example in FIG. 4b. The horizontal orientation of the cylindrical microlenses 33 as illustrated in the left-hand image in FIG. 4b leads to a brightness difference and/or color difference because, as has in particular already been discussed further above, the microlenses 33 change the angle of incidence α₂ of the light which is incident on the first security element 2 in the overlap region 41 in relation to the light which is incident in the comparison region 42. The first security element 2 provides the same zeroth order color effect in the comparison region 41 as in the overlap region 41, but without an overlying surface structure 3, in particular without microlenses 33. Different color effects are thus cast into the eye of the viewer owing to the different angles of incidence.

After the security document 1 has been rotated for example through 90°, as illustrated by the right-hand image in FIG. 4b, the incident light strikes the security document 1 along the cylinder direction. The lines within the “UT” show in particular the orientation of the cylindrical microlenses 33. Here, the view is directed in particular along the y direction, that is to say also along the cylinder direction of the microlenses 33. The angle of incidence oz is in this case not changed, or not changed to a strongly perceptible degree, in relation to a′2, with the result that the overlap region 41, which in this case for example has the form of the alphabetic characters “UT”, has the same or approximately the same color and/or brightness of the zeroth order color effect as the comparison region 42 without the surface structures 3. In FIG. 4b, this is shown by way of example by a different illustration of the two alphabetic characters “UT”.

FIG. 5 shows the photograph of a further example. In this, the surface structure 34 is formed by linear elevations, which are arranged in the surface region 43 in the form of a semicircular ornament. Situated below said surface structure 34 is a preferably areal first region 40 or subregion thereof having a first security element 2 which has a zeroth order color effect, in particular a zeroth order color effect as described with regard to FIGS. 4a and 4b. The region 40 or subregion thereof is for example present over the entire region shown by the photograph. The photograph shows an illumination situation and viewing situation in which the zeroth order color effect is not visible or is scarcely visible in the comparison region 42, that is to say in regions without the surface structure 3, because the condition of direct reflection is not satisfied. By contrast, in the overlap region 41, that is to say in the region of the security element 2 having the zeroth order color effects overlapping the ornament, the color effect of the underlying first security element 2 is visible, because the surface structure 34 changes the exit angle of the light. In particular, the view, which may constitute the first viewing situation, is directed with a viewing angle at which the first security element 2 would not be visible without the surface structures 34. The expansion and change of the exit angle of the light in the overlap region 41 however renders the first security element 2 visible there. Thus, the ornament illustrated by FIG. 5 in this case exhibits for example a red color in parts and a green color in parts, this being generated in particular by the first security element 2 and constituting the contrasting light property 410. The first security element is however transparent comparison region 42, such that other layers of the security document, such as printed layers, form the reference light property 420.

The design variants presented may self-evidently be combined with one another as desired, and do not constitute any limitation.

### LIST OF REFERENCE SIGNS

1 Security document
11 Covering layer
12 Personalization layer
13 Transparent layer
14 Transparent layer
15 Core layer
16 Transparent layer
101, 102 Motifs
2 First security element
3 Surface structure
31 Matte structure
32 Microprisms
33 Microlenses
34 Linear elevations
40 First region
41 Overlap region
42 Comparison region
43 Surface structure region
400 Design
410 Contrasting light property
420 Reference light property
430 Third light property
51 Incident light
52 Radiated light
63 Pre-printed information items
64 Personalized data
α₁, α₂, α₃, α₄, α₅ Angle of incidence or angle of emergence
β₁, β₂ Angle of expansion

1. A security document having a first security element, which has a first optically variable effect, in a first region and having an exposed surface structure arranged on a first outer face of the security document,
wherein the security document has an overlap region, in which the surface structure overlaps the first security element, and a comparison region, in which the first security element is present but the surface structure does not overlap the first security element;
wherein,
in a first viewing situation, a reference light property, which is a defined color and/or defined brightness, is visible in the comparison region,
wherein the surface structure is configured such that, in the first viewing situation, the surface structure causes a change in light which is incident on the first security element and/or in light which is radiated from the first security element, such that a contrasting light property, which is a defined color and/or defined brightness and which is generated by the first optically variable effect of the first security element, is visible in the overlap region,
wherein the contrasting light property-differs from the reference light property by a defined color difference and/or a defined brightness difference, and
wherein the first security element comprises the following layers in the first region: at least one replication layer having at least one relief structure; at least one reflection layer, wherein the reflection layer is arranged on the at least one relief structure.

2. The security document according to claim 1, wherein the defined color difference and/or brightness difference is determined by a total color difference dE, and lies in a range from 3 to 270.

3. The security document according to claim 1, wherein the change in light which is incident on the first security element and/or in light which is radiated from the first security element comprises one or more of the following changes: variation of the angle of emergence, variation of the angle of incidence.

4. The security document according to claim 1, wherein the security document has one or more designs, and the first region forms one or more first design elements and/or the comparison region forms one or more second design elements and/or the overlap region forms one or more third design elements and/or the surface structure is arranged in a surface region and the surface structure region forms one or more fourth design elements.

5. The security document according to claim 4, wherein the overlap region and/or the comparison region has a width of at least 3 mm, and/or an area of at least 1 mm×1 mm.

6. The security document according to claim 1, wherein the overlap region is in the form of or consists of one or more first motifs which are visible in the first viewing situation.

7. The security document according to claim 6, wherein the first region is in the form of one or more second motifs which are visible.

8. The security document according to claim 6, wherein the one or more first motifs have at least one contour line which extends from the comparison region into the overlap region, and/or wherein the one or more second motifs have at least one contour line which extends from the comparison region into the overlap region.

9. The security document according to claim 1, wherein the surface structure has one or more of the following structures: a matte structure, microprisms, microlenses, linear elevations and/or linear depressions.

10. The security document according to claim 1, wherein
the light exiting at the surface structure is expanded by the surface structure by an angle (β2) in a range from 0.5° to 45°.

11. The security document according to claim 9, wherein the matte structure is an isotropically scattering matte structure or an anisotropically scattering matte structure.

12. The security document according to claim 9, wherein the matte structure has an average spacing of randomly or pseudorandomly varying elements in a range from 1 μm to 100 μm.

13. The security document according to
claim 9, wherein the matte structure has a structure depth in a range from 0.5 μm to 20 μm.

14. The security document according to claim 1, wherein the change in light which is incident on the first security element is or comprises a change in the angle of incidence of the light which is incident on the first security element, such that light which passes through the surface structure has a first angle of incidence (α2) on the first security element and light which enters the security document outside the surface structure is incident on the first security element with a second angle of incidence (α′2), wherein the first angle of incidence (α2) and the second angle of incidence (α′2) differ in terms of angle.

15. The security document according to claim 14, wherein the difference in the angle is at least 2°.

16. The security document according to claim 1, wherein the surface structure has or consists of microprisms.

17. The security document according to, claim 16, wherein the microprisms are triangular prisms.

18. The security document according to claim 1, wherein the surface structure has or consists of microlenses.

19. The security document according to claim 18, wherein the microlenses are or comprise cylindrical lenses and/or spherical microlenses.

20. (canceled)

21. The security document according to claim 1, wherein the at least one relief structure comprises a first relief structure which is present both in the overlap region and in the comparison region, and/or wherein the first relief structure extends, at least in parts, uninterruptedly from the overlap region into the comparison region.

22. The security document according to claim 20, wherein the first region is a closed region or is made up of a plurality of subregions, which have the first relief structure and/or one or more further relief structures.

23. The security document according to claim 1, wherein the at least one relief structure is or comprises a subwavelength grating for generating zeroth order color effects.

24. The security document according to claim 23, wherein the subwavelength grating for generating zeroth order color effects has one or more of the following shapes: cruciform, hexagonal, pseudorandom.

25. The security document according to claim 23, wherein the subwavelength grating for generating zeroth order color effects has a grating period in a range from 180 nm to 420 nm.

26. The security document according to claim 23, wherein the subwavelength grating for generating zeroth order color effects has a grating depth in a range from 80 nm to 350 nm.

27. The security document according to claim 23, wherein the subwavelength grating for generating zeroth order color effects has an asymmetrical profile shape.

28. The security document according to claim 1, wherein the at least one relief structure is or comprises a relief structure for generating achromatic lighting-up effects.

29. The security document according to claim 28, wherein the relief structure for generating achromatic lighting-up effects is a diffraction grating.

30. The security document according to claim 28, wherein the relief structure for generating achromatic lighting-up effects has a grating period of at least 3 μm.

31. The security document according to claim 28, wherein the relief structure for generating achromatic lighting-up effects has a grating period of less than 50 μm.

32. The security document according to claim 28, wherein the relief structure for generating achromatic lighting-up effects has one or more of the following profile shapes: blaze-shaped, rectangular, sinusoidal.

33. The security document according to claim 28, wherein the relief structure for generating achromatic lighting-up effects has one or more of the following microstructures: micromirrors, microfacets, microprisms.

34. The security document according to claim 33, wherein the microstructures of the relief structure for generating achromatic lighting-up effects have a lateral extent in a range from 3 μm to 50 μm.

35. The security document according to claim 28, wherein the surface structure is configured such that, in the first viewing situation, the contrasting light property exhibits the achromatic effect.

36. The security document according to claim 9, wherein, in the first view, the achromatic effect is visible both in the overlap region and in the comparison region, wherein a lower brightness is however present in the overlap region owing to the expansion by the matte structure.

37. The security document according to claim 1, wherein the at least one relief structure is or comprises a diffraction grating for generating chromatic lighting-up effects.

38. The security document according to claim 37, wherein the diffraction grating for generating chromatic lighting-up effects has a grating period of at least 0.5 μm and of less than 3 μm.

39. The security document according to, claim 37, wherein the diffraction grating for generating chromatic lighting-up effects has one or more of the following profile shapes: blaze-shaped, rectangular, sinusoidal.

40. The security document according to claim 1, wherein the at least one relief structure is or comprises a subwavelength grating for generating non-metallic zeroth order colors and/or brightnesses.

41. The security document according to claim 40, wherein the subwavelength grating for generating non-metallic zeroth order colors and/or brightnesses has a grating period in a range from 180 nm to 420 nm.

42. The security document according to claim 40, wherein the subwavelength grating for generating non-metallic zeroth order colors and/or brightnesses has a grating depth t in a range from 50 nm to 250 nm.

43. The security document according to claim 40, wherein the subwavelength grating for generating non-metallic zeroth order colors and/or brightnesses is linear, cruciform, hexagonal or pseudorandom.

44. The security document according to, claim 40, wherein the subwavelength grating for generating non-metallic zeroth order colors and/or brightnesses has a profile shape which is rectangular or sinusoidal.

45. The security document according to claim 40, wherein the subwavelength grating for generating non-metallic zeroth order colors and/or brightnesses has at least two diffraction gratings having different azimuth angles, wherein respective sequences of elevations and depressions having a defined grating period and a defined grating depth extend along each azimuth angle.

46. The security document according to claim 1, wherein the first optically variable effect, which constitutes the contrasting light property in the overlap region, is visible in the comparison region in a further viewing situation.

47. The security document according to claim 1, wherein, in a second viewing situation, a third color and/or third brightness is visible in the overlap region and in the comparison region, or a third color and/or third brightness is visible in the comparison region and a fifth color and/or fifth brightness is visible in the overlap region.

48. The security document according to claim 1, wherein the reference light property is generated by light which is diffracted in the zeroth order of diffraction by the first security element.

49. The security document according to claim 1, wherein the contrasting light property is generated by light which is diffracted in the zeroth order of diffraction by the first security element.

50. A method for producing a security document comprising the following steps
providing at least one covering layer;
providing at least one core layer;
providing a first security element having a first optically variable effect;
arranging the at least one core layer, the at least one covering layer and the first security element such that the first security element is arranged between the at least one covering layer and the at least one core layer;
pressing together the at least one covering layer and the at least one core layer, wherein a surface structure is impressed into the at least one covering layer such that the surface structure is arranged, exposed, on a first outer face of the security document, and the security document has an overlap region, in which the surface structure overlaps the first security element, and a comparison region, in which the first security element is present but the surface structure does not overlap the first security element, such that, in a first viewing situation, a reference light property, which is a defined color and/or defined brightness, is visible in the comparison region, wherein the surface structure is configured such that, in the first viewing situation, the surface structure in the overlap region causes a change in light which is incident on the first security element and/or in light which is radiated from the first security element, such that a contrasting light property, which is a defined color and/or defined brightness and which is generated by the first optically variable effect of the first security element, is visible in the overlap region, wherein the contrasting light property differs from the reference light property by a defined color difference and/or a defined brightness difference,
wherein the first security element comprises the following layers in the first region: at least one replication layer having at least one relief structure; at least one reflection layer, wherein the reflection layer is arranged on the at least one relief structure.

51. The method according to claim 50, wherein the method is carried out in a laminating press, wherein the surface structure is formed into the at least one covering layer by means of a press plate of the laminating press during the pressing-together operation.
